(19) United States
(12) Patent Application Publication
(10) Pub. No.: US 2025/0162088 A1
(43) Pub. Date: May 22, 2025

(54) REDUCED THERMAL HEAT LOAD AND DISTORTION OF AUTOMATED WELD ASSEMBLIES FOR THERMALLY AND STRUCTURALLY OPTIMIZED ADDITIVE MANUFACTURED COMPONENTS

(71) Applicant: Divergent Technologies, Inc., Los Angeles, CA (US)

(72) Inventors: Gordon TAJIRI, Los Angeles, CA (US); Michael Thomas Kenworthy, Rancho Palos Verdes, CA (US); Bahram Issari, Laguna Niguel, CA (US)

(21) Appl. No.: 18/955,672

(22) Filed: Nov. 21, 2024

Related U.S. Application Data
(60) Provisional application No. 63/601,637, filed on Nov. 21, 2023.

(51) Int. Cl. B23K 35/36; B23K 20/12; B23K 35/02; B23K 101/00; B33Y 80/00

(52) U.S. Cl. CPC B23K 35/3602; B23K 20/122; B23K 35/0255; B23K 2101/006; B33Y 80/00

(57) ABSTRACT

An additively manufactured component and method for producing a component from multiple components by welding or adhering an additively manufactured component to a second component. The additively manufactured component includes a joining portion configured to be welded to the second component, and a heat management feature for removing heat from the joining portion.

### CROSS-REFERENCE TO RELATED APPLICATION

This application claims the benefit of U.S. Provisional Application No. 63/601,637 entitled “Reduced Thermal Heat Load and Distortion of Automated Weld Assemblies for Thermally and Structurally Optimized Metal Additive Structural Components” and filed Nov. 21, 2023, which is expressly incorporated by reference herein in its entirety.

### BACKGROUND

### Field

The present disclosure relates to heat management and structural reinforcement features for manufactured components.

### Background

Additive manufacturing (AM) systems can produce metal structures (referred to as build pieces) with geometrically complex shapes, including some shapes that are difficult or impossible to create with conventional manufacturing processes. (AM) techniques are used to create build pieces layer-by-layer, i.e., slice-by-slice. The process can be repeated to form the next slice of the build piece, and so on. Because each layer is deposited on the previous layer, AM allows for the formation of structures that were previously not possible to be formed by traditional non-AM manufacturing technologies.

### SUMMARY

The following presents a simplified summary of one or more aspects of the invention in order to provide a basic understanding of such aspects. This summary is not an extensive overview of all contemplated aspects and is intended to neither identify key or critical elements of all aspects nor delineate the scope of any or all aspects. Its purpose is to present some concepts of one or more aspects in a simplified form as a prelude to the more detailed description that is presented later.

Aspects of the disclosure relate to an additively manufactured (AM) component configured to be welded to a second component, the additively manufactured component including a portion configured to be welded to the second component, and a heat management feature for removing heat from the joining portion when the joining portion is welded to the second component.

Aspects of the disclosure further relate to a structural vehicle component with a first additively manufactured component with a first component first joining feature and a first component second joining feature; a second additively manufactured component with a second component first joining feature joined to the first component first joining feature via an adhesive and a second component second joining feature; and a joint structure spanning from the first component second joining feature to the second component second joining feature, wherein a first end of the joint structure is welded to the first component second joining feature and a second end of the joint structure is welded to the second component second joining feature.

Aspects of the disclosure further relate to a method for joining an additively manufactured component to a second component, the method including joining an additively manufactured component joining portion of the additively manufactured component to a second component joining portion of the second component via welding while removing heat generated by the welding via a heat management feature of the additively manufactured component.

It will be understood that other aspects of combined components and methods for producing components will become readily apparent to those skilled in the art from the following detailed description, wherein it is shown and described in the detailed examples by way of illustration. As will be realized by those skilled in the art, the disclosed subject matter may be varied or modified, all without departing from the present disclosure. Accordingly, the drawings and detailed description are to be regarded as illustrative in nature and not as restrictive.

### BRIEF DESCRIPTION OF THE DRAWINGS

FIGS. 1a-1d illustrate example powder bed fusion (PBF) systems during different stages of operation.

FIG. 2 illustrates one example of a wire directed energy deposition (DED) AM apparatus.

FIG. 3 illustrates an example of certain aspects of a direct metal deposition (DMD) AM apparatus.

FIG. 4a illustrates one example of an assembly with heat management features according to aspects of the disclosure.

FIG. 4b illustrates an assembled state of the assembly of FIG. 4a according to aspects of the disclosure.

FIG. 5a illustrates one example of an assembly with heat management features according to aspects of the disclosure.

FIG. 5b illustrates an assembled state of the assembly of FIG. 5a according to aspects of the disclosure.

FIG. 6 illustrates an example of a welding process according to aspects of the disclosure.

FIG. 7 illustrates an example microstructure resulting from the welding process of FIG. 6 according to aspects of the disclosure.

FIGS. 8a-8d show example joint structures and weld paths according to aspects of the disclosure.

FIG. 9a shows an example of an assembly according to aspects of the disclosure.

FIG. 9b is a partial cross-section view of the assembly of FIG. 9a. according to aspects of the disclosure.

FIG. 10 illustrates an example assembly system, which includes a plurality of robots configured to perform various operations for assembly of and joining of the assemblies described herein.

FIG. 11 illustrates a melting enthalpy chart for various phase change materials usable with aspects of the disclosure.

FIG. 12 illustrates an example representative diagram of various components of an example controller usable with aspects of the disclosure.

FIG. 13 illustrates an example of a computer system in accordance with aspects of the disclosure.

FIG. 14 illustrates an example of various system components in accordance with aspects of the present disclosure.

### DETAILED DESCRIPTION

The detailed examples set forth below in connection with the appended drawings is intended to provide a description of various exemplary embodiments of the concepts disclosed herein and is not intended to represent the only embodiments in which the disclosure may be practiced. The detailed description includes specific details for the purpose of providing a thorough and complete disclosure that fully conveys the scope of the concepts to those skilled in the art. However, the disclosure may be practiced without these specific details. In some instances, well-known structures and components may be shown in block diagram or simplified form, or omitted entirely, to avoid obscuring the various concepts presented throughout this disclosure.

### I. Terminology

Reference throughout this specification to one aspect, an aspect, one example or an example means that a particular feature, structure or characteristic described in connection with the embodiment or example may be a feature included in at least example of the present invention. Thus, appearances of the phrases in one aspect, in an aspect, one example or an example in various places throughout this specification are not necessarily all referring to the same example. Furthermore, the particular features, structures or characteristics may be combined in any suitable combinations and/or sub combinations in one or more embodiments or examples.

The term exemplary used in this disclosure means serving as an example, instance, or illustration, and should not necessarily be construed as preferred or advantageous over other embodiments presented in this disclosure.

Throughout the disclosure, the terms substantially or approximately may be used as a modifier for a geometric relationship between elements or for the shape of an element or component. While the terms substantially or approximately are not limited to a specific variation and may cover any variation that is understood by one of ordinary skill in the art to be an acceptable level of variation, some examples are provided as follows. In one example, the term substantially or approximately may include a variation of less than 10% of the dimension of the object or component. In another example, the term substantially or approximately may include a variation of less than 5% of the object or component. If the term substantially or approximately is used to define the angular relationship of one element to another element, one non-limiting example of the term substantially or approximately may include a variation of 5 degrees or less. These examples are not intended to be limiting and may be increased or decreased based on the understanding of acceptable limits to one of skill in the relevant art.

For purposes of the disclosure, directional terms are expressed generally with relation to a standard frame of reference when the aspects or articles described herein are in an in-use orientation. In some examples, the directional terms are expressed generally with relation to a left-hand coordinate system.

Terms such as a, an, and the, are not intended to refer to only a singular entity, but also include the general class of which a specific example may be used for illustration. The terms a, an, and the, may be used interchangeably with the term at least one. The phrases at least one of and comprises at least one of followed by a list refers to any one of the items in the list and any combination of two or more items in the list. All numerical ranges are inclusive of their endpoints and non-integer values between the endpoints unless otherwise stated.

The terms first, second, third, and fourth, among other numeric values, may be used in this disclosure. It will be understood that, unless otherwise noted, those terms are used in their relative sense only. In particular, certain components may be present in interchangeable and/or identical multiples (e.g., pairs). For these components, the designation of first, second, third, and/or fourth may be applied to the components merely as a matter of convenience in the description.

The term additive manufacturing (AM) or AM component may be used throughout the disclosure. The term AM includes any known additive manufacturing or 3D printing technique. Some examples include but are not limited to power bed fusion, direct energy deposit (DED), fused deposition modeling (FDM), stereolithography (SLA), wire or extrusion-based DED. Accordingly, all additive manufacturing and 3D printing techniques are applicable without departing from the principles of this disclosure including those that are currently contemplated or under commercial development. The aspects of the disclosure may additionally be relevant to non-metal additive manufacturing and or metal/adhesive additive manufacturing (e.g., binderjetting), which may forgo an energy beam source and instead apply an adhesive or other bonding agent to form each layer. In the case of binderjetting, the cured or green form may be sintered or fused in a furnace and/or be infiltrated with bronze or other alloys.

The terms powder bed fusion (PBF) is used throughout the disclosure. PBF systems may encompass a wide variety of additive manufacturing (AM) techniques, systems, and methods. Thus, the PBF system or process as referenced in the disclosure may include, among others, the following printing techniques: direct metal laser sintering (DMLS), electron beam melting (EBM), selective heat sintering (SHS), selective laser melting (SLM) and selective laser sintering (SLS). PBF fusing and sintering techniques may further include, for example, solid state sintering, liquid phase sintering, partial melting, full melting, chemical binding and other binding and sintering technologies.

The term fusing may be used throughout the disclosure to describe any permanent fixing or adhering of AM powder or other known materials. In some examples, the term fusing may include sintering, melting, and/or adhering (e.g., via bonding agent or adhesive) individual powder particles.

The term non-AM manufacturing may be used throughout the disclosure to encompass any manufacturing technique other than AM. Some examples may include any one or combination of subtractive manufacturing techniques (e.g., machining) and/or extrusions, stampings, forgings, moldings, or castings, to name a few non-limiting examples. Further, non-AM may refer to any known method for forming non-metallic components. For example, non-AM may also encompass components formed of composites including any one or combination of carbon fibers, para-aramid (Kevlar™), fiberglass, or substrates thereof that are bonded or otherwise laminated via a synthetic polymer (e.g., epoxy, vinyl ester, polyester resins or combinations thereof).

The term welding may be used throughout the disclosure to describe any permanent or semi-permanent joining of two or more structures or features. While the term welding is not intended to be limited to examples named herein, some examples include joining of materials, typically metals or thermoplastics, through the application of heat, pressure, or a combination of both, the objective being to create a permanent bond between the materials, which can be achieved using various techniques and methods including but not limited to arc welding, shielded metal arc welding, gas metal arc welding, gas tungsten art welding, oxy-fuel welding, resistance welding, spot welding, seam welding, laser welding, electron beam welding, friction welding, plasma arc welding, brazing or soldering.

The term friction or stir welding may be used throughout the disclosure to describe any permanent or semi-permanent joining of two or more structures or features. While not intended to be limiting, stir welding may include any solid-state welding process that joins materials by applying a rotating tool to the workpieces. The heat generated from the friction between the tool and the workpiece, combined with the mechanical stirring action of the tool, leads to the softening of the material allowing two or more surfaces or objects to be forged together.

The term structural component in a vehicle may include but is not limited to a frame, subframe, or a component that receives a load due to vehicle driving dynamics. In some examples, the term structural component may distinguish from other vehicle components, e.g., seats, steering wheel, exhaust, etc.

### II. Overview

Additive Manufacturing (AM) systems can produce structures with geometrically complex shapes, including some shapes that are difficult or impossible to create with conventional manufacturing processes. Further, AM systems provide unmatched efficiency in quickly producing components and for freedom in designing and quickly changing structures as needs change or as structures are further optimized without needing to re-tool as is typically required using conventional non-AM manufacturing processes.

Often, when combining multiple components to form a product, for example an automobile or subsections thereof, multiple AM components and/or a combination of AM components(s) and non-AM components(s) may need to be joined to form desired structures. When joining multiple additively manufactured components through processes such as welding, stir welding, or use of structural adhesives, excessive heat during the joining process and/or during use of the joined component can lead to warping, residual stress, failure of the adhesive, and/or material degradation. These adverse effects can compromise the integrity and performance of the final assembly. Therefore, there is a need for effective heat management and/or structural support strategies that can be integrated into the design of the additively manufactured parts themselves. In the examples described herein, various heat management features and systems are incorporated into additive manufactured components that are optimized for heat management of the components to be joined. Some examples include but are not limited to thermal sinks, heat transfer passages, and/or integration of phase change materials. For example, thermal sinks may include fins or lattice structures that increase surface area in contact with fluids (e.g., air) and/or phase change materials to control heat at a joint. Heat transfer passages may be implemented to transfer heat way from the joint. Phase change materials (PCMs) may be implemented to absorb and release heat during phase transitions to stabilize temperature fluctuations during joining of components and/or during use of multi-component structures.

### III. Detailed Examples

Additive manufacturing (AM) systems, such as powder bed fusion (PBF) systems can produce structures (referred to as build pieces) with geometrically complex shapes, including some shapes that are difficult or impossible to create with conventional manufacturing processes. PBF systems create build pieces layer-by-layer, i.e., slice-by-slice. Each slice can be formed by a process of depositing a layer of powder (e.g., metal or metallic powder) and fusing (e.g., melting and cooling) areas of the metal powder layer that coincide with the cross-section of the build piece in the slice. The process can be repeated to form the next slice of the build piece, and so on.

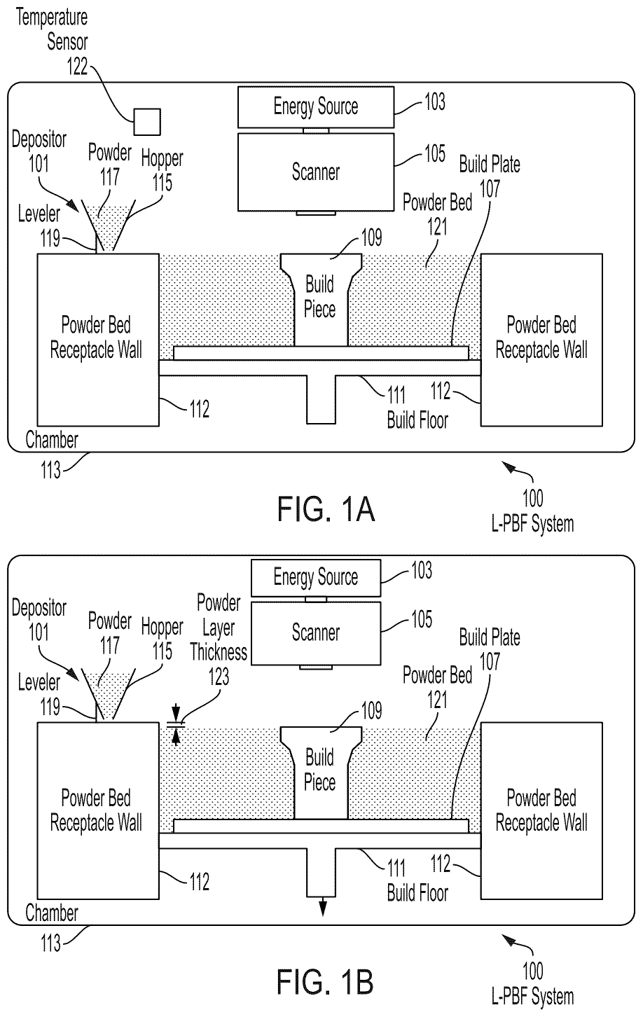

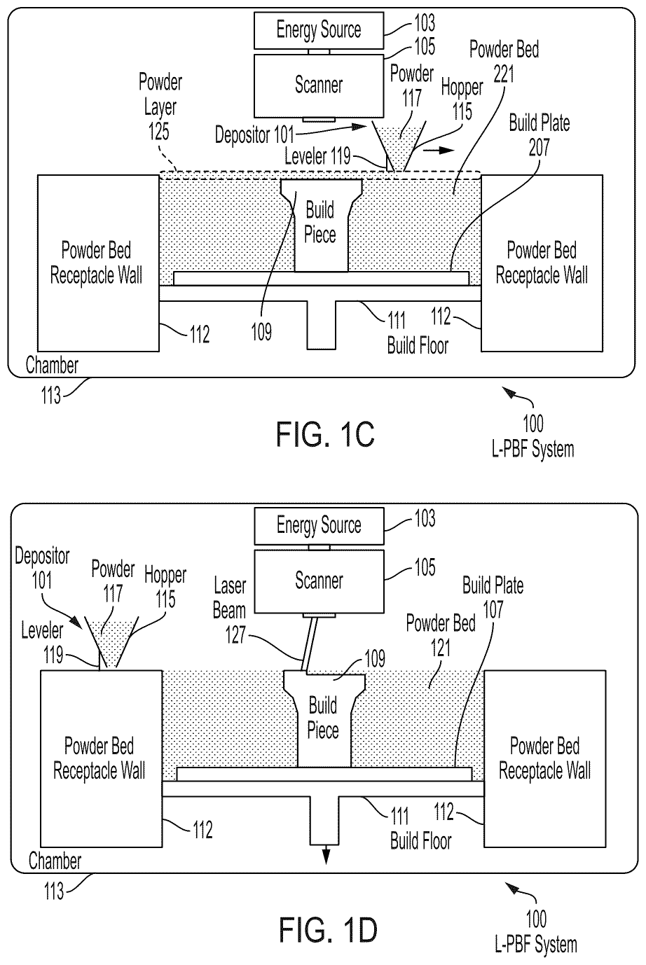

FIGS. 1a-d illustrate respective side views of an example of a PBF system 100 usable with aspects of the disclosure during different stages of operation. As noted above, the particular embodiment illustrated in FIGS. 1a-d is one of many suitable examples of a PBF system employing principles of this disclosure. It should also be noted that elements of FIGS. 1a-d and the other figures in this disclosure are simplified and not necessarily drawn to scale, but may be drawn larger or smaller and/or with reduced detail for the purpose of better illustration of concepts described herein. PBF system 100 can include a depositor 101 that can deposit each layer of metal powder, an energy beam source 103 that can generate an energy beam, a scanner 105 that can direct or redirect the energy beam to fuse the powder material, and a build plate 107 that can support one or more build pieces, such as a build piece 109.

PBF system 100 can also include a build floor 111 positioned within a powder bed receptacle. The walls of the powder bed receptacle 112. Build floor 111 can progressively lower build plate 107 so that depositor 101 can deposit a next layer. In some examples, the entire mechanism may reside in a chamber 113 that can enclose the other components, thereby protecting the equipment, enabling atmospheric (e.g., providing an inert environment) and temperature regulation and mitigating contamination risks. Depositor 101 can include a hopper 115 that contains a powder 117, such as a metal powder, and a leveler 119 that can level the top of each layer of deposited powder.

Referring specifically to FIG. 1a, this figure shows PBF system 100 after a slice of build piece 109 has been fused, but before the next layer of powder has been deposited. In fact, FIG. 1a illustrates a time at which PBF system 100 has already deposited and fused a partially completed build piece in multiple layers to form the current state of build piece 109. The multiple layers already deposited have created a powder bed 121, which includes powder that was deposited but not fused.

FIG. 1b shows PBF system 100 at a stage in which build floor 111 can lower by a powder layer thickness 123. The lowering of build floor 111 causes build piece 109 and powder bed 121 to drop by powder layer thickness 123, so that the top of the build piece and powder bed are lower than the top of powder bed receptacle wall 112 by an amount equal to the powder layer thickness. In this way, for example, a space with a consistent thickness equal to powder layer thickness 123 can be created over the tops of build piece 109 and powder bed 121.

FIG. 1c shows PBF system 100 at a stage in which depositor 101 is positioned to deposit powder 117 in a space created over the top surfaces of build piece 109 and powder bed 121 and bounded by powder bed receptacle walls 112. In this example, depositor 101 moves over the defined space while releasing powder 117 from hopper 115. Leveler 119 can level the released powder to form a powder layer 125 that has a thickness substantially equal to the powder layer thickness 123 (see FIG. 1b). Thus, the powder in a PBF system can be supported by a powder material support structure, which can include, for example, a build plate 107, a build floor 111, a build piece 109, walls 112, and the like. It should be noted that the illustrated thickness of powder layer 125 (i.e., powder layer thickness 123 (FIG. 1b)) is greater than an actual thickness used for the example involving 150 previously-deposited layers discussed above with reference to FIG. 1a.

FIG. 1d shows PBF system 100 at a stage in which, following the deposition of powder layer 125 (FIG. 1c), energy beam source 103 generates an energy beam 127 and a scanner 105, directs, and/or redirects the energy beam along the surface of the powder layer 125 to melt, sinter, and/or melt the next slice in build piece 109. In various aspects of the disclosure, energy beam source may be one or more lasers 103, in which case energy beam 127 is a laser beam. The scanner may include one or more motors, galvos, gimbals, optics, etc. Controlling one or more mirrors and/or lenses for reflection and/or refraction to manipulate the laser beam to scan selected areas of the powder layer may include an optical system that uses one or more motors controlling one or more mirrors and/or lenses for reflection and/or refraction to manipulate the laser beam to scan selected areas of the powder layer 125 to be fused. The scanner 105 may include one or more gimbals and actuators, which may be motor-controlled, that can rotate and/or translate the energy beam source to position the energy beam and/or optics such as a focusing or de-focusing optic or optics to allow for focusing/de-focusing of the energy beam. In various aspects, energy beam source 103 and/or scanner 105 can modulate the energy beam, e.g., turn the energy beam on and off and/or control the divergence of the energy beam 103 as the scanner 105 scans so that the energy beam is applied only in the appropriate areas of the powder layer(s) and/or to control the energy applied to the powder layer(s). For example, in various aspects of the disclosure, the energy beam can be modulated by a digital signal processor (DSP). The deflector may include any known system in the art, for example a galvo-scanner or galvanometer, and/or a raster scanner. It is noted that while a single energy beam source 103 and/or scanner 105 is shown, aspects of the disclosure are usable with and may include a system with multiple energy source(s) and/or scanners.

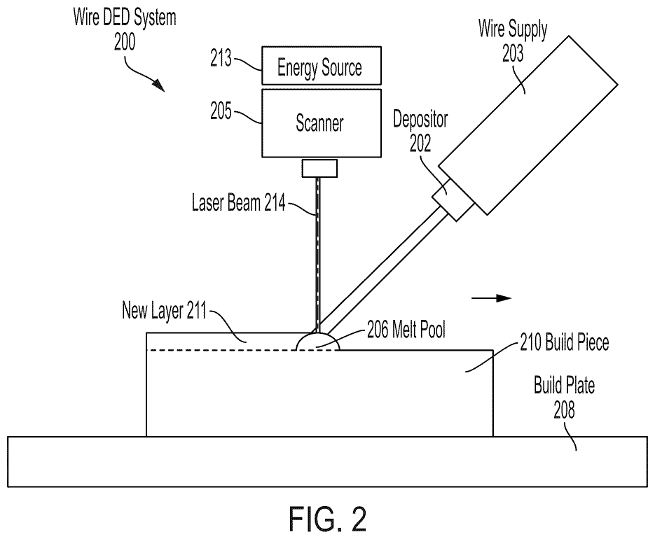

FIG. 2 illustrates an example wire Directed Energy Deposition (“DED”) system 200 for AM using wire or extrusions. A wire DED system 200 can include a depositor 202 that can deposit each layer of wire or extruded material from a supply apparatus 203, a laser 203 or other energy source can generate heat to melt each layer of material upon deposition and form a melt pool 206, and a build plate 208 that can support one or more build pieces, such as build piece 210. The example of FIG. 2 shows wire DED system 200 after multiple layers of build piece 210 have each been deposited, and while a new layer 212 is being deposited. While depositing the new layer, build piece 210 can remain stationary, and depositor 202 and laser 204 can cross a length and width of the build piece while releasing wire and generating heat, respectively. Alternatively, or in combination with movement of the laser 203, the build piece 210 can move under the depositor and laser 203. The laser 204 may generate a laser beam 114, which may pass through or otherwise be affected by an optical system scanner 205 that uses reflection and/or refraction to manipulate the laser beam to scan selected areas to be fused.

In various aspects of the disclosure, the scanner 205 can include one or more gimbals and actuators that can rotate and/or translate the laser source to position the energy beam. By controlling the scanner 205, the laser beam 214 can be scanned in the x-direction and/or y-direction to allow for scanning of the laser over the wire or an extrusion from the depositor 202. In various aspects, energy beam source 103 and/or the scanner 205 can modulate the energy beam, e.g., turn the energy beam on and off and/or focus/de-focus the beam as the scanner 205 scans so that the energy beam is applied only in the appropriate areas of the wire or extrusion provided by the depositor. For example, in various aspects of the disclosure, the energy beam can be modulated by a digital signal processor (DSP). The scanner 205 may include any known system in the art, for example a galvo-scanner or galvanometer, and/or a raster scanner. It is noted that while a single energy beam source 203 and/or scanner 205 is shown, aspects of the disclosure are usable with and may include a system with multiple energy source(s) and/or deflector(s).

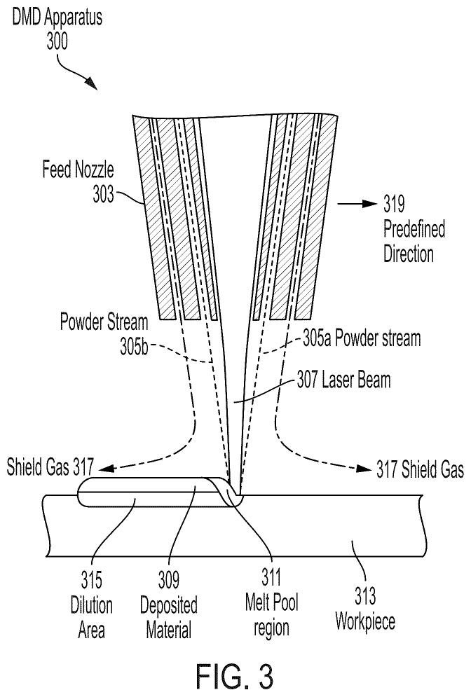

In another example of the AM techniques that can be used to form an AM component, is direct metal deposition (DMD). FIG. 3 illustrates an example embodiment of certain aspects of a DMD apparatus 300. DMD apparatus 300 uses a feed nozzle 303 moving in a predefined direction 319 to propel powder streams 305a and 305b into a laser beam 307, which is directed toward a workpiece 313 that may be supported by a substrate. Feed nozzle 303 may also include mechanisms for streaming a shield gas 317 to protect the welded area from oxygen, water vapor, or other components.

The powdered metal is then fused by laser 307 in a melt pool region 311, which may then bond to workpiece 313 as a region of deposited material 309. A dilution area 315 may include a region of workpiece 313 where the deposited powder is integrated with the local material of workpiece 313. Feed nozzle 303 may be supported by a computer numerical controlled (CNC) robot or a gantry (e.g., a robot or gantry as described below with respect to FIG. 3), or other computer-controlled mechanism. Feed nozzle 303 may be moved under computer control multiple times along a predetermined direction of the substrate until an initial layer of deposited material 309 is formed over a desired area of workpiece 313. Feed nozzle 303 can then scan the region immediately above the prior layer to deposit successive layers until the desired structure is formed. In general, feed nozzle 303 may be configured to move with respect to all three axes, and in some instances to rotate on its own axis by a predetermined amount.

When forming an AM component, a data model of the desired 3-D object to be manufactured is rendered. A data model is a virtual design of the 3-D object. Thus, the data model may reflect the geometrical and structural features of the 3-D object, as well as its material composition. The data model may be created using a variety of methods, including CAE-based optimization, 3-D modeling, photogrammetry software, and camera imaging. CAE-based optimization may include, for example, cloud-based optimization, fatigue analysis, linear or non-linear finite element analysis (FEA), and durability analysis.

3-D modeling software, in turn, may include one of numerous commercially available 3-D modeling software applications. Data models may be rendered using a suitable computer-aided design (CAD) package. Thereupon, CAD package may further implement error analysis steps under which the 3-D model may be analyzed, and errors identified and resolved.

Following error resolution, the data model can be ‘sliced’ by a software application known as a slicer to thereby produce a set of instructions for “3-D printing” the object, with the instructions being compatible and associated with the particular 3-D printing technology to be utilized. Numerous slicer programs are commercially available. Generally, the slicer program converts the data model into a series of individual layers representing thin slices (e.g., 50-500 microns thick or thicker if other AM methods besides PBF are implemented) of the object be printed, along with a file containing the AM apparatus specific instructions for printing these successive individual layers to produce a buildpiece or workpiece representation of the data model.

The layers associated with AM methods and related instructions need not be planar or identical in thickness. For example, in some embodiments depending on factors like the technical sophistication of the AM equipment and the specific manufacturing objectives, etc., the layers in the buildpiece structure may be non-planar and/or may vary in one or more instances with respect to their individual thicknesses.

In addition to the instructions that dictate what and how an object is to be formed, the appropriate physical materials necessary for use by AM apparatus in forming the buildpiece are provided to the AM apparatus using any of several conventional and often AM apparatus specific methods. In DMD techniques, for example, one or more metal powders may be provided for layering structures with such metals or metal alloys. In selective laser melting (SLM), selective laser sintering (SLS), and other PBF-based AM methods (see below), the materials may be provided as powders into chambers that feed the powders to a build platform. Depending on the AM apparatus, other techniques for providing printing materials may be used.

The respective data slices of the 3-D object are then printed based on the provided instructions using the material(s). In an AM apparatus that uses laser sintering, a laser scans a powder bed and melts the powder together where structure is desired as described above with respect to FIGS. 1a-1D, and avoids scanning areas where the sliced data indicates that nothing is to be printed. This process may be repeated until the desired structure or buildpiece is formed, after which the buildpiece is removed from the AM apparatus (either manually or in an automated process). In fused deposition modelling, as described above, parts are built by applying successive layers of model and support materials to a substrate. In general, any suitable AM technology or 3-D printing technology is contemplated and may be employed to form components described herein for purposes of the present disclosure.

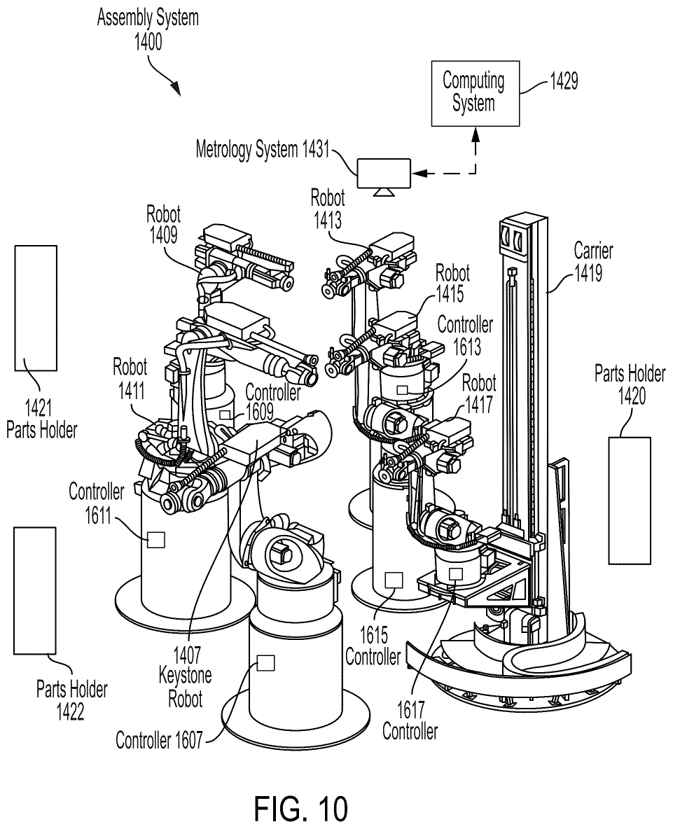

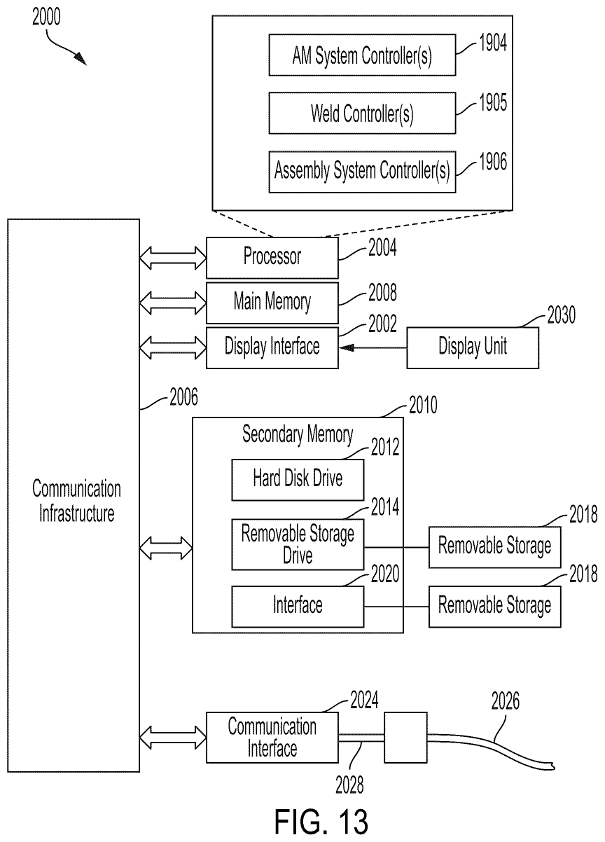

Any one or combination of the assembly, welding and/or AM manufacturing apparatuses described above may be manual controlled or may be full or partial (e.g., combined manual and automated) computer numerical control (CNC) manufacturing apparatuses with any one or all of the operations being computer controlled. Additional aspects of computer our automated control of the aspects described herein are described in further detail below with respect to FIGS. 10 and 12-14. While examples are provided herein, automated assembly and joining of components as contemplated by this disclosure are not limited to aspects or features listed or described herein and may include any known system or method.

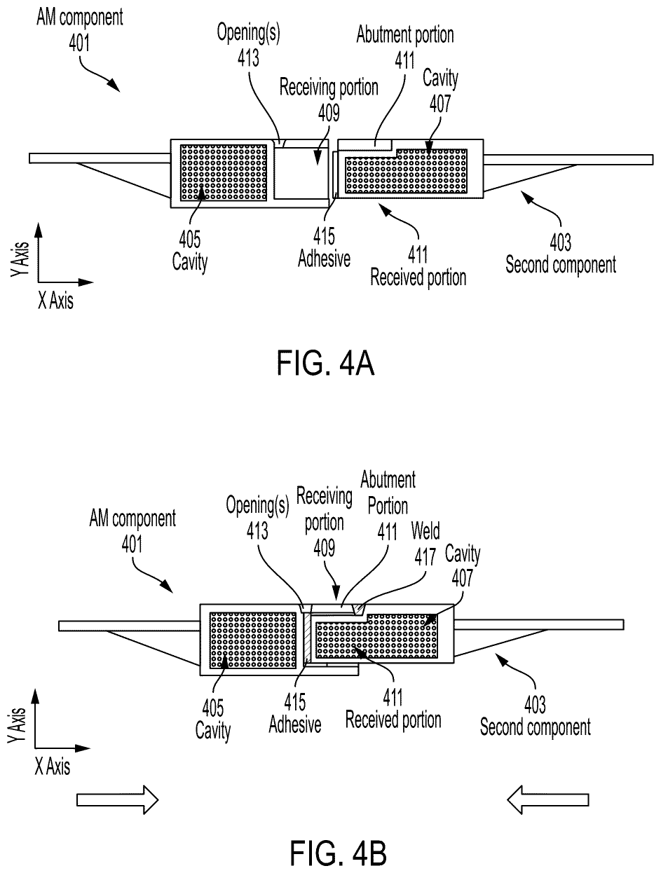

FIGS. 4a and 4b show examples of an AM component that includes heat management feature(s) for controlling temperatures either during joining of the AM component with another component and/or for controlling temperatures during the life-cycle of the component. FIG. 4a shows one example of an AM component 401 which may be joined with or configured to be joined with a second component 403. In some examples, the second component 403 may be traditionally or non-AM manufactured. In other aspects of the disclosure, the second component 403 may be an AM component. The AM component 401 may include a joining region or section that is to be permanently joined to the second component 403. In one example implementation the joining region or section may include a receiving portion 409. The receiving portion 409 may for example be a concavity or a channel that is dimensioned to receive a corresponding received portion 411 of the second component 403.

In some examples, the AM component 401 may include a cavity 405 with heat management features therein. In some examples (e.g., as shown in FIGS. 4a and 4b), the heat management features may be a lattice structure within the cavity that is formed to increase the surface area in contact with a fluid (e.g., air) within the cavity 405. In additional examples (as further described below), the cavity 405 may be filled or partially filled with a liquid or other fluid and/or may be filled or partially filled with a phase change material that removes heat energy from portions of the AM component 401 proximal to the receiving portion 409. It is noted that while an example lattice structure is shown in FIGS. 4a and 4b, any structure that increases the surface area within the cavity 405 and/or that functions as a heat-sink may be implemented without departing from the scope of this disclosure.

Further, in some examples, the second component 403 may include a cavity 407 with heat management features therein. In some examples (e.g., as shown in FIGS. 4a and 4b), the heat management features may be a lattice structure within the cavity that is formed to increase the surface area in contact with a fluid (e.g., air) within the cavity 407. In additional examples (as further described below), the cavity 407 may be filled or partially filled with a liquid or other fluid and/or may be filled or partially filled with a phase change material that removes heat energy from portions of the second component 403 proximal to the received portion 411. It is noted that while an example lattice structure is shown in FIGS. 4a and 4b, any structure that increases the surface area within the cavity 407 and/or that functions as a heat-sink may be implemented without departing from the scope of this disclosure.

FIG. 4b shows one example of the assembly process of an AM component 401 and a second component 403 according to aspects of the disclosure. In one example, an adhesive 415 may be applied to one or more surfaces of the received portion 411. Then, the AM component 401 and the second component 403 may be assembled as indicated by the arrows in FIG. 4b. The aforementioned assembly and adhesive installation may be completed manually (e.g., by an assembler or technician), or may be partially or fully automated as described in additional detail below with respect to FIG. 10. The adhesive may be any known adhesive or foaming adhesive. In some example implementations, the adhesive may be a two-part curable adhesive such as an epoxy, urethane, or urethane foam, expanding or foaming adhesive, or other adhesive or bonding agent. In another example, the adhesive and/or foam may cure when heat is applied and thus the connected combination structure may be subjected to heating and/or placed in an autoclave or oven to cure the adhesive at the connection. In yet another example, the adhesive may be an ultraviolet (UV) curable adhesive or bonding agent that is configured to solidify or cure when subject to UV light. In some examples either one of or both of the AM component 401 and/or the second component 403 may include one or more window slots or opening(s) 413. The opening(s) may be configured to have UV light shined therethrough to cure adhesive 415 once the AM component 401 and the second component 403 are installed or otherwise connected to one another and in a desired alignment (e.g., as shown in FIG. 4b).

In some examples, the aforementioned adhesive 415 may be used to temporarily hold or otherwise maintain alignment between the AM component 401 and the second component 403 until the two components are permanently joined, for example via welding as described below. Either one of or both of the AM component 401 and/or the second component 403 may include one or more openings (e.g., opening 413) and or other joining features that are configured to have adhesive injected thereinto and/or for curing of adhesive via UV light or chemical reaction, for example. Further, windows or openings may be included for welding of the component in other locations besides the joint between the AM component 401 and the second component 403.

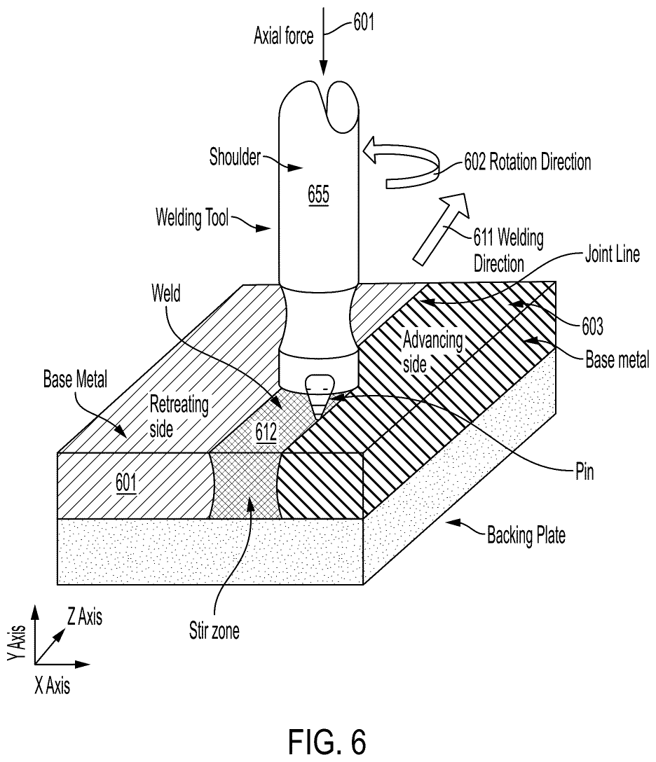

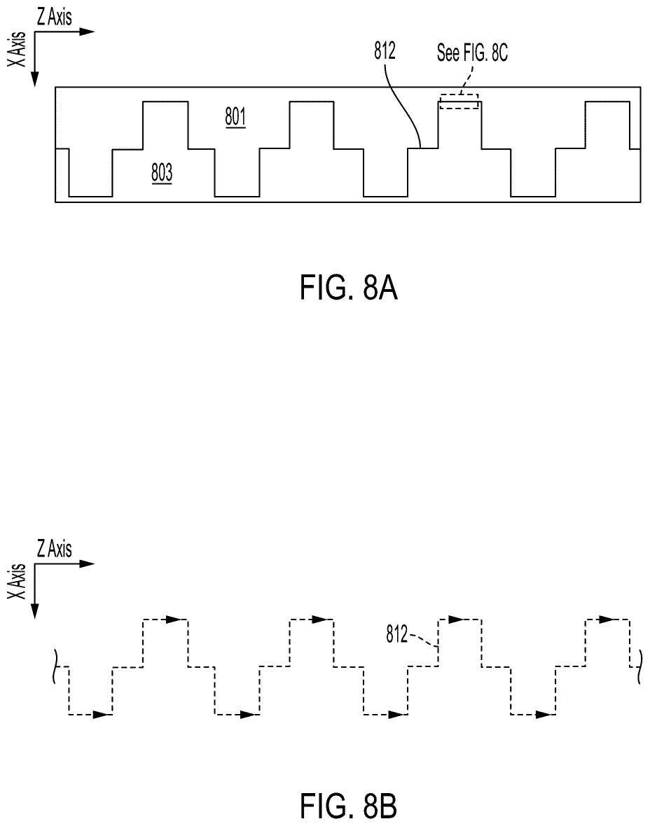

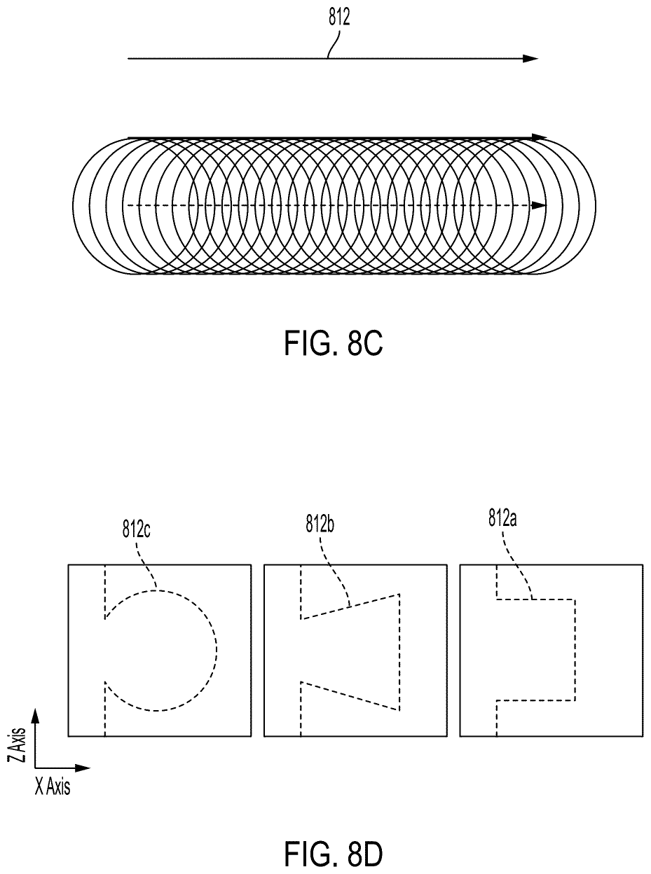

As noted above, in one example implementation of the joining of AM component 401 and second component 403, a welding process may be used to join the two components by welding at one or more joints (e.g., as shown by reference 417 in FIG. 4b). In some examples, the AM component 401 and second component 403 may be welded together via a stir welding or friction welding technique (as described in detail below with respect to FIGS. 6-8d. Further, as discussed below, the joint and/or welding pattern may be non-linear or may include keyed or notched features as described below with respect to FIGS. 8a-8d.

The heat management features in cavities 405 and/or 407 may be configured to remove heat energy from or to otherwise decrease the temperature at the joint of the AM component 401 and/or the second component 403 during a welding process. Decreasing localized heat during the welding process may prevent any one or combination of distortion, residual stresses, and metallurgical changes in the heat-affected zone and/or may improve microstructure of the material at the weld/joint as described below. To further improve localized heat at the joint during welding/joining of the AM component 401 with the second component 403, stir welding and/or friction welding may be used as described in detail below.

As noted above, an adhesive 415 may be implemented to either temporarily join the AM component 401 and the second component 403 prior to welding and/or to structurally join the AM component 401 and the second component 403. The heat management features in cavities 405 and/or 407 may further prevent failure of the adhesive 415 due to excessive heat either during assembly of the AM component 401 and second component 403 and/or when the assembled components are in-use. Reducing or otherwise removing heat at the joint during use of the components may be advantageous if either one of or both of the assembled AM component 401 and/or the second component 403 are subjected to high heat or temperature fluctuations during use, for example in an engine compartment or as engine components.

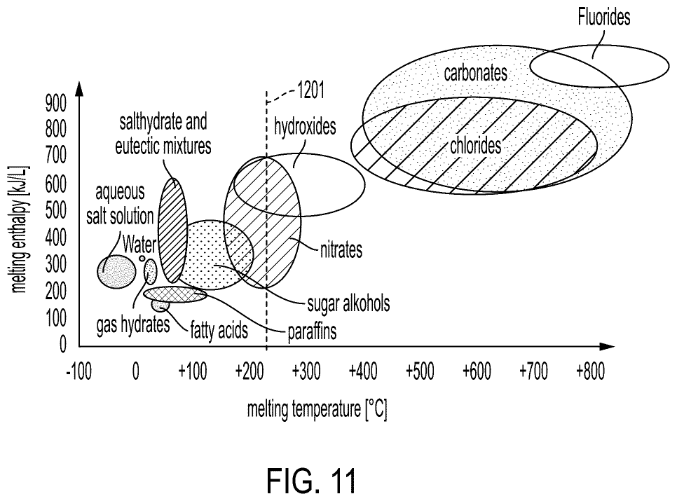

In one example implementation, either one of or both of the cavities 405 and/or 407 may be configured to be filled with phase change materials. Phase change materials (PCMs) are substances that absorb or release thermal energy during phase transitions, providing a way to regulate temperature. Thus, the thermal profile of the weld zone can be controlled more effectively, resulting in improved thermal management during the welding process. As shown in diagram in FIG. 11, various materials with different melting enthalpy ranges may be used to control heat at or near the joint of the AM component 401 and/or the second component 403. In one example, any nitrate and hydroxide may be selected as PCMs and added to any one of or both of the cavities 405 and/or 407 due to their thermal properties and phase transition characteristics. Some non-limiting examples of nitrates includes but are not limited to: sodium nitrate (NaNO₃), sodium nitrite (NaNO₂), or potassium nitrate (KNO₃) and the like, which may include solutions thereof and/or binary and ternary mixtures. Some examples of hydroxides may include but are not limited to barium hydroxide octahydrate (Ba(OH)2·8H2O), magnesium hydroxide (Mg(OH)2), aluminum hydroxide (Al(OH)3), or sodium hydroxide (NaOH) or the like, and may include solutions thereof and/or binary and ternary mixtures. It is noted that the aforementioned materials are merely provided as examples, any PCM may be selected based on the desired temperature of the joint or region adjacent to the joint. As noted above, if a maximum temperature of 200 Celsius to 300 Celsius is desired as indicated by line 1201 in FIG. 11, the selected PCMs may include the aforementioned nitrates and hydroxides The quantity or volume of PCM may be determined based on the change in enthalpy during the transient change in phase.

In some examples, prior to initiating the welding process, either one of or both of the cavities 405 and/or 407 are filled with a selected nitrate or hydroxide PCM. The phase change material may be allowed to reach thermal equilibrium with the surrounding environment. During welding, as heat is generated, the PCM absorbs excess thermal energy, transitioning from solid to liquid and maintaining a near constant temperature during the phase transition. This process helps to maintain a stable temperature in the weld zone, reducing the risk of overheating and associated defects. Upon completion of the welding operation and/or other decrease in temperature, the PCM can re-solidify.

In another example usable with the aforementioned example, the PCM may be configured to manage heat near the cavities 405 and/or 407 to prevent an adhesive (e.g., adhesive 415) from overheating and weakening when subjected to high heat or temperature fluctuations during use. The aforementioned implementation of PCMs (and management of heat at the adhesive 415) may be especially advantageous in preventing structural adhesives from softening or glass-transitioning at temperatures greater than 100 Celsius when the joint and/or either one of the AM component 401 and/or second component 403 are located near or at exhausts or turbocharger components, within the engine bay, and/or anywhere else vehicle components may be subject to high heat and/or heat fluctuations. It is noted that the aforementioned PCM materials may be used in combination with or in leu of the aforementioned AM heat management features (e.g., lattice structures or other thermal sinks) within the cavities 405 and/or 407. For example, the cavities 405 and/or 407 may have the lattice structures or other AM formed heat sink features shown in FIGS. 4a and 4b omitted and the cavities may instead be filled with a PCM material, or materials as described above.

In another example usable with any one or combination of the features described herein, the cavities 405 and/or 407 may be configured to have fluid (e.g., a gas or liquid) passed therethrough or cycled therethrough during a welding step to cool the joint during welding to prevent localized overheating at the joint. For example, either one of or both of the cavities 405 and/or 407 may have a fluid pump connected thereto so that a fluid is cycled within the cavity. It is noted that the aforementioned cycling of fluid within the cavities may be used in combination with or in leu of the aforementioned AM heat management features (e.g., lattice structures of other thermal sinks) within the cavities 405 and/or 407. For example, the cavities 405 and/or 407 may have the lattice structures or other AM formed heat sink features shown in FIGS. 4a and 4b omitted and the cavities may instead be an open cavity for cycling of fluid therein. In another example usable with any of the aforementioned examples, once the welding operation is complete, the aforementioned fluid may be drained from the cavities 405 and/or 407, and any one or combination of the PCMs described above may be added to one or more cavities, and any openings for providing fluid(s) and/or PCM(s) sealed-off to allow for further heat management at the joint when the AM component 401 and/or the second component 403 are in use in a vehicle.

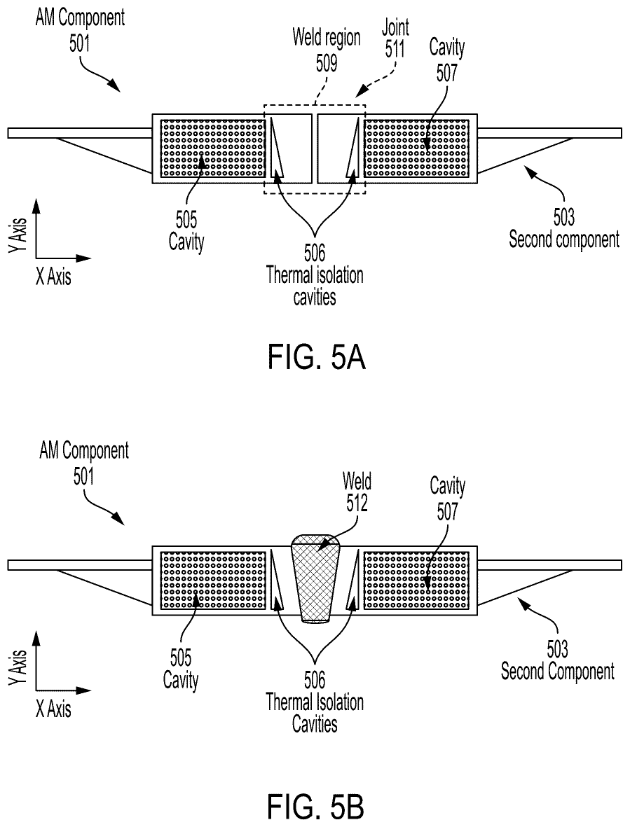

FIGS. 5a and 5b show further examples of an AM component that includes heat management feature(s) for controlling temperatures either during joining of the AM component with another component and/or for controlling temperatures during the life cycle of the component. FIG. 5a shows one example of an AM component 501 which may be joined with or configured to be joined with a second component 503. In some examples, the second component 503 may be traditionally or non-AM manufactured. In other aspects of the disclosure, the second component 503 may be an AM component. The AM component 501 may include a joining region or section 509 (alternatively referred to herein as a weld region) that is to be permanently joined to the second component 503.

In some examples, the AM component 501 may include a cavity 505 with heat management features therein. In some examples (e.g., as shown in FIGS. 5a and 5b), the heat management features may be a lattice structure within the cavity that is formed to increase the surface area in contact with a fluid (e.g., air) within the cavity 505. In additional examples (as further described below), the cavity 505 may be filled or partially filled with a liquid or other fluid and/or may be filled or partially filled with a phase change material that removes heat energy from portions of the AM component 501 at the weld region 509. It is noted that while an example lattice structure is shown in FIGS. 5a and 5b, any structure that increases the surface area within the cavity 505 and/or that functions as a heat-sink may be implemented without departing from the scope of this disclosure. The AM component 501 may further include one or more thermal isolation cavities 506 as heat management features. The thermal isolation cavities may function to create a thermal barrier to trap process heating and/or create a thermal break and reduce the energy load at the cavity 505 and/or 507 (described below) and may further prevent heat soak or localized overheating in regions outside the weld area during a welding process. In some examples, the thermal isolation cavities may be an airspace or other cavity filled with air. In other examples, the thermal isolation cavities may be filled with fluid or have fluid cycled therethrough and/or may include a phase change material as described in further detail below.

The second component 503 may include a cavity 507 with heat management features therein. In some examples (e.g., as shown in FIGS. 5a and 5b), the heat management features may be a lattice structure within the cavity that are formed to increase the surface area in contact with a fluid (e.g., air) within the cavity 507. In additional examples (as further described below), the cavity 507 may be filled or partially filled with a liquid or other fluid and/or may be filled or partially filled with a phase change material that removes heat energy from portions of the second component 503 proximal to the weld region 509. It is noted that while an example lattice structure is shown in FIGS. 5a and 5b, any structure that increases the surface area within the cavity 507 and/or that functions as a heat-sink may be implemented without departing from the scope of this disclosure. The second component 503 may further include one or more thermal isolation cavities 506. The thermal isolation cavities may function to create a thermal barrier to trap process heating and reduce the energy load at the cavity 507 and/or 505 and may further prevent heat soak or localized overheating in regions outside the weld area during a welding process. In some examples, the thermal isolation cavities 506 may be an airspace or other cavity filled with air. In other examples, the thermal isolation cavities may be filled with fluid or have fluid cycled therethrough and/or may include a phase change material as described in further detail below.

FIG. 5b shows one example of the assembly process of an AM component 501 and a second component 503 according to aspects of the disclosure. In one example, the joint 511 between the AM component 501 and the second component 503 may be welded to form a weld 512 permanently affixing or otherwise connecting the AM component 501 to the second component 503. As described in further detail below, the alignment and welding of the components may be completed manually (e.g., by an assembler or technician), or may be partially or fully automated using a series of robots as described in additional detail below with respect to FIG. 10.

In some examples, the AM component 501 and second component 503 may be welded together via any known welding process. In another aspect that is usable in combination with the aforementioned welding technique the AM component 501 and the second component 503 may be joined via a stir welding or friction welding technique (as described in detail below with respect to FIGS. 6-8d. Further, as discussed in additional detail below, the joint and/or welding pattern may be linear and/or non-linear or may include keyed or notched features as described below with respect to FIGS. 8a-8d.

The heat management features in cavities 505 and/or 507 may be configured to remove heat energy from or to otherwise decrease the temperature at the joint of the AM component 501 and/or the second component 503 during a welding process. Decreasing localized heat during the welding process may prevent any one or combination of distortion, residual stresses, and metallurgical changes in the heat-affected zone and/or may improve microstructure of the material at the weld/joint as described below. To further improve localized heat at the joint during welding/joining of the AM component 501 with the second component 503, stir welding and/or friction welding may be used as described in detail below. Further, the aforementioned thermal isolation cavities 506 may reduce the thermal load and/or heat soak beyond the weld region 509.

In one example implementation, either one of or combination of the cavities 405 and/or 407 and/or the thermal isolation cavities 506 may be configured to be filled with PCMs that absorb or release thermal energy during phase transitions, providing a way to regulate temperature. Thus, the thermal profile of the weld zone 509 can be controlled more effectively, resulting in improved thermal management during the welding process. As shown in diagram in FIG. 10, various materials with different melting enthalpy ranges may be used to control heat at or near the joint of the AM component 501 and/or the second component 503. In one example, any nitrate and hydroxide may be selected as PCMs and added to any one of or both of the cavities 505 and/or 507 and/or 506 due to their thermal properties and phase transition characteristics. It is noted that the aforementioned materials are merely provided as examples, any PCM may be selected based on the maximum desired temperature of the region adjacent to the joint. As noted above, if a maximum temperature of 200 Celsius to 300 Celsius is desired the selected PCMs may include the aforementioned nitrates and hydroxides The quantity or volume of PCM may be determined based on the change in enthalpy during the transient change in phase.

In some examples, prior to initiating the welding process, either one or any combination of the cavities 505 and/or 507 and/or 506 are filled with a selected nitrate or hydroxide PCM. The phase change material may be allowed to reach thermal equilibrium with the surrounding environment. During welding, as heat is generated, the PCM absorbs excess thermal energy, transitioning from solid to liquid and maintaining a near constant temperature during the phase transition. This process helps to maintain a stable temperature in the weld zone, reducing the risk of overheating and associated defects. Upon completion of the welding operation and/or other decrease in temperature, the PCM can solidify. It is noted that the aforementioned PCM materials may be used in combination with or in leu of the aforementioned AM heat management features (e.g., lattice structures of other thermal sinks) within the cavities 505 and/or 507 and/or 506. For example, the cavities 505 and/or 507 and/or 506 may have the lattice structures or other AM formed heat sink features as shown in FIGS. 5a and 5b omitted and the cavities may instead be filled with a PCM material, or materials as described above.

In another example usable with any one or combination of the features described herein, the cavities 505 and/or 507 and/or 506 may be configured to have fluid (e.g., a gas or liquid) passed therethrough or cycled therethrough during a welding step to cool the joint during welding to prevent localized overheating at the joint. For example, either one of or both of the cavities 505 and/or 507 and/or 506 may have a fluid pump connected thereto so that a fluid is cycled within the cavity. It is noted that the aforementioned cycling of fluid within the cavities may be used in combination with or in leu of the aforementioned AM heat management features (e.g., lattice structures of other thermal sinks) within the cavities 505 and/or 507 and/or 506. For example, the cavities 505 and/or 507 and/or 506 may have the lattice structures or other AM formed heat sink features shown in FIGS. 5a and 5b omitted and the cavities may instead be an open cavity for cycling of fluid therein. In another example usable with any of the aforementioned examples, once the welding operation is complete, the aforementioned fluid may be drained from any one or combination of the cavities 405 and/or 407 and/or 509, and any one or combination of the PCMs described above may be added to one or more cavities, and any openings for providing fluid(s) and/or PCM(s) sealed-off to allow for further heat management at the joint when the AM component 501 and/or the second component 503 are in use in a vehicle, for example.

While the welding processes described herein could include any known welding process, one welding process which provides additional advantages is micro friction stir welding (uFSW). FIG. 6 shows one example of a uFSW process which may be used to join components as described herein (e.g., the aforementioned AM components 401 and 501 and second components 403 and 503). Typically, when creating larger lightweight structural assemblies, the individual components are precisely aligned and joined, but thin-walled aluminum alloy components are easily distorted from high assembly force and thermal distortion loads. Standard high heat input welding methods may distort thermally conductive, e.g., aluminum, structural assemblies. A uFSW process is a localized low-energy joining method that can be used to repeatably join low-mass/thin walled assemblies. The uFSW process described herein is a solid-state welding process that joins materials by applying a rotating tool 655 to the workpieces (e.g., a first component 601, which may be analogous with AM component(s) 401 and 501 described above and a second component 603, which may be analogous with second component(s) 403 and 503 described above). As shown in FIG. 6, the tool rotates (e.g., in direction 602) as an axial force 601 is applied thereto. The heat generated from the friction between the tool 655 and the workpieces 601 and 602, combined with the mechanical stirring action of the tool, leads to the softening of the material allowing it to be forged together. This produces high-quality welds with minimal defects and significantly improves the quality of welds of thin metal workpieces (e.g., aluminum alloy as described above).

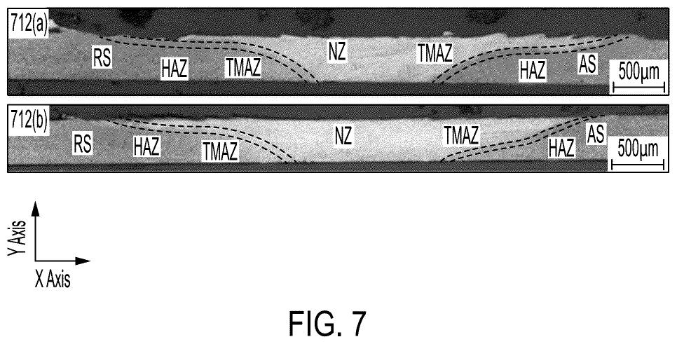

FIG. 7 shows example cross-sectional views of the microstructure of joints/welds using a uFSW process. 712(a) shows an example of the welding of two materials at a rotating speed (e.g., with the tool rotating in direction 602) of 1150 rotations per minute (rpm). 712(b) shows an example of the microstructure of the welding of two materials at a rotating speed of 2000 rpm.

FIGS. 8a and 8b show example weld paths for joining two or more components according to aspects of this disclosure. In one example, a first component 801, which may be analogous with the AM components 401 and 501 described above or 901 described below may have a toothed or otherwise non-linear joint that is configured to engage with or otherwise fit-with a toothed or otherwise non-linear joint of a second component 801, with may be analogous with second components 403 and 503 described above and/or second component 903 described below. The rotating tool (e.g., 655 described above) may follow the path while rotating (e.g., as shown below in FIG. 8c). The non-linear tool path and non-linear weld may further improve the strength of the weld between the two or more components and may further prevent deformation or other defects at the weld. Alternative non-limiting examples of weld-paths 812a, 812b, and 812c are further shown in FIG. 8d.

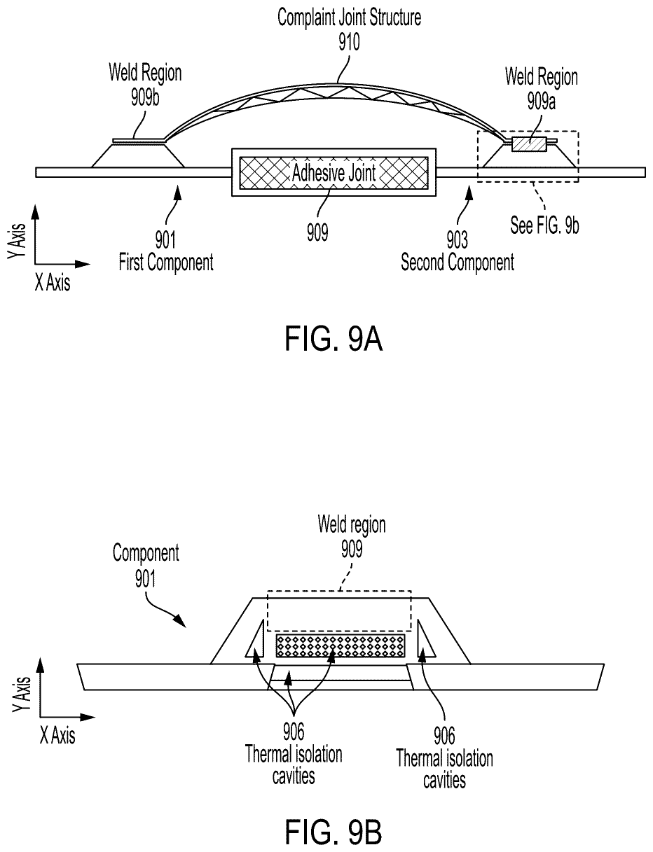

FIGS. 9a and 9b shows another example of components with specific geometries optimized for joining via welding and/or for heat management. An example first component 901 may be joined with or configured to be joined with a second component 903. In some examples, either one of or both the first component and/or the second component 903 may be traditionally or non-AM manufactured. In other aspects of the disclosure, any one or both of the first component 901 and the second component 903 may be an AM component. The first component 901 and/or the second component 903 may include a primary joining region or section 909 that is to be utilized to permanently join the first component 901 to the second component 903. In the example shown in FIG. 9a, the first component 901 and the second component 903 may be joined via an adhesive joint 909. The adhesive may be any known adhesive or foaming adhesive. In some example implementations, the adhesive may be a two-part curable adhesive such as an epoxy, urethane, or urethane foam, expanding or foaming adhesive, or other adhesive or bonding agent. In another example, the adhesive and/or foam may cure when heat is applied and thus the connected combination structure may be subjected to heating and/or placed in an autoclave or oven to cure the adhesive at the connection. In yet another example, the adhesive may be an ultraviolet (UV) curable adhesive or bonding agent that is configured to solidify or cure when subject to UV light. In some examples either on of or both of the first component 901 and/or the second component 903 may include one or more window slots or opening(s) (not shown). The opening(s) may be configured to have UV light shined therethrough to cure adhesive at the adhesive joint 909 once the first component 901 and the second component 903 are installed or otherwise connected to one another and in a desired alignment.

To further strengthen the joining of the first component 901 and the second component 903, a compliant joint structure 910 (alternatively referred to herein as a joint structure) may be utilized. The complaint joint structure may be a rigid, semi-rigid, and/or semi-elastic structure and may be configured to span from the first component at a first component second joining feature 909b (alternatively referred to herein as a weld region) to the second component at a second component second joining feature 909a (alternatively referred to herein as a weld region). In some examples, the complaint joint structure 910 may be manufactured using a traditional or non-AM manufacturing method. In another example, the compliant joint structure may be manufactured using an AM manufacturing process. The complaint joint structure 910 may be configured to be adhered to or welded to weld regions (e.g., 909a and/or 909b) or the second joining features of the first component 901 and the second component 903 to improve the strength of the overall structure. In some examples, the compliant joint structure 910 may be permanently connected to the first component 901 and the second component 903 at the weld regions 909a and 909b via the uFSW process described above. As described in further detail below, the alignment and welding of the components may be completed manually (e.g., by an assembler or technician), or may be partially or fully automated using a series of robots as described in additional detail below with respect to FIG. 10.

FIG. 9b shows a partial magnified cross-section view of one example of a weld region (e.g., weld region 909a and/or 909b) or second joining features of either the first component 901 or the second component 903. As shown in FIG. 9b, either one of or both of the first component 901 and/or the second component 903 may be an AM component and may include a cavities 906 with heat management features therein and/or that function as thermal isolation cavities. The heat management features and/or thermal isolation cavities may share features with or may be analogous with any of the thermal isolation cavities and/or heat management features described with respect to FIGS. 4a, 4b, 5a and/or 5b. The heat management features may be a lattice structure within the cavity that is formed to increase the surface area in contact with a fluid (e.g., air) within the cavity. Further, the lattice structure implemented in the cavity may provide structural support to counteract the axial force (e.g., force applied in direction 601 in FIG. 6) during a uFSW process.

In additional examples (as further described below), any one or combination of the cavities 906 may be filled or partially filled with a liquid or other fluid and/or may be filled or partially filled with a phase change material that removes heat energy from portions the weld region 909. It is noted that while an example lattice structure is shown in FIG. 9b, any structure that increases the surface area within the cavity and/or that functions as a heat-sink may be implemented without departing from the scope of this disclosure. The AM component 901 and/or the second component 903 may further include one or more thermal isolation cavities. The thermal isolation cavities may function to create a thermal barrier to trap process heating and reduce the energy load, and may further prevent heat soak or localized overheating in regions outside the weld area during a welding process. In some examples, the thermal isolation cavities may be an airspace or other cavity filled with air. In other examples, the thermal isolation cavities may be filled with fluid or have fluid cycled therethrough and/or may include a phase change material as described in further detail below.

The complaint joint structure 910 and each of the weld regions 909a and/or 909b may be welded together via any known welding process. In another aspect that is usable in combination with the aforementioned welding technique they may be joined via a stir welding or friction welding technique (as described in detail above with respect to FIGS. 6-8d. Further, as discussed above, the joint and/or welding pattern may be linear and/or non-linear or may include keyed or notched features as described below with respect to FIGS. 8a-8d.

The heat management features in cavities 906 may be configured to remove heat energy from or to otherwise decrease or stabilize the temperature at the joint during a welding process. Decreasing localized heat during the welding process may prevent any one or combination of distortion, residual stresses, and metallurgical changes in the heat-affected zone and/or may improve microstructure of the material at the weld/joint as described below. To further improve localized heat at the joint during welding/joining complaint joint structure with the first component 901 and/or the second component 903, stir welding and/or friction welding may be used as described in detail above. Further, the aforementioned thermal isolation cavities 906 may reduce the thermal load and/or heat soak beyond the weld region 909.

In one example implementation, any on or combination of the cavities 906 may be configured to be filled with PCMs that absorb or release thermal energy during phase transitions, providing a way to regulate temperature. Thus, the thermal profile of the weld zone 909 can be controlled more effectively, resulting in improved thermal management during the welding process. As shown in the diagram in FIG. 10, various materials with different enthalpy ranges may be used to control heat at or near the joint. In one example, any nitrate and hydroxide may be selected as PCMs and added to any or combination of the cavities 906 due to their thermal properties and phase transition characteristics. It is noted that the aforementioned materials are merely provided as examples, any PCM may be selected based on the maximum desired temperature of the region adjacent to the joint. As noted above, if a maximum temperature of 200 Celsius to 300 Celsius is desired as indicate by line 1201 in FIG. 11 the selected PCMs may include the aforementioned nitrates and hydroxides The quantity or volume of PCM may be determined based on the enthalpy during the transient change in phase. In some examples, prior to initiating the welding process any one or combination of the cavities 906 may be filled with a selected nitrate or hydroxide PCM. The phase change material may be allowed to reach thermal equilibrium with the surrounding environment. During welding, as heat is generated, the PCM absorbs excess thermal energy, transitioning from solid to liquid and maintaining a near constant temperature during the phase transition. This process helps to maintain a stable temperature in the weld zone, reducing the risk of overheating and associated defects. Upon completion of the welding operation and/or other decrease in temperature, the PCM can solidify. It is noted that the aforementioned PCM materials may be used in combination with or in leu of the aforementioned AM heat management features (e.g., lattice structures of other thermal sinks) within the cavities 906. For example, the above mentioned any one or combination of cavities 906 may have the lattice structures or other AM formed heat sink features as shown in FIG. 9b omitted and the cavities may instead be filled with a PCM material, or materials as described above.

In another example usable with any one or combination of the features described herein, any one or combination of the cavities 906 may be configured to have fluid (e.g., a gas or liquid) passed therethrough or cycled therethrough during a welding step to cool the joint during welding to prevent localized overheating at the joint. For example, any one or combination of the cavities 906 may have a fluid pump connected thereto so that a fluid is cycled within the cavity. It is noted that the aforementioned cycling of fluid within the cavities may be used in combination with or in leu of the aforementioned AM heat management features (e.g., lattice structures of other thermal sinks) within the cavities. For example, the cavities may have the lattice structures or other AM formed heat sink features shown in FIG. 9b omitted and the cavities may instead be an open cavity for cycling of fluid therein. In another example usable with any of the aforementioned examples, once the welding operation is complete, the aforementioned fluid may be drained from any one or combination of the cavities 906, and any one or combination of the PCMs described above may be added to one or more cavities, and any openings for providing fluid(s) and/or PCM(s) sealed-off to allow for further heat management at the joint while the component is in use in a vehicle, for example. By combining stir welding with optimized AM thermal and structural features components can be permanently assembled with reduced distortions. Further, the combination of the AM thermal and structural features described herein with the uFSW described below allows for the process of creating components, assembling components, and welding or otherwise connecting multiple components to be automated as described in further detail below.

The steps described above may be partially automated or fully automated. For example, any one or combination of the manufacturing or acquiring of components, alignment, welding, adhering and/or UV curing and/or heat management steps may be partially or fully automated.

One example of the aforementioned automation includes an assembly system and/or method. FIG. 10 shows non-limiting examples for automating the methods of manufacturing combined components described herein with an assembly system 1400. In one example, the assembly system 1400 may be a fixtures assembly system. At least one of the structures of the disclosed component may be additively manufactured, e.g., as described with respect to FIGS. 1a-3 above. In some aspects, at least one of the at least two structures may be a piece, part, node, component, and/or other additively manufactured structure, which may include two structures that previously have been joined. For example, a structure or a part may be at least a portion or section associated with a vehicle, such as a vehicle chassis, panel, base piece, body, frame, suspension components, brake component, and/or another vehicle component that will be combined with one or more non-AM components.

The structures to be joined in association with assembly of a combined component may be manufactured with one or more features that may facilitate or enable various assembly operations (e.g., joining) without the use of fixtures, such as one or more features to prevent or reduce unintended movement of a structure and/or deflection of the structure during one or more fixtureless assembly operations. For example, one or more structures to be joined in association with fixtureless assembly of a vehicle may be additively manufactured with one or more features designed to provide stability, strength, and/or rigidity during various fixtureless assembly operations (e.g., as describe above with respect to FIGS. 4a and 4b). Additional examples of such features may include mesh, honeycomb, and/or lattice substructures, which may be co-printed with a structure (e.g., when the structure is additively manufactured) and which may be internal and/or external to the structure.

In one example, an assembly system may include a plurality of robots, at least one of which may be positioned to join one structure with another structure without the use of fixtures. A first robot may be configured to engage with and retain a first structure to which one or more other structures may be joined during various operations performed in association with fixtureless assembly of at least a portion of a larger assembly. For example, the first robot may engage and retain a first structure that is or includes an AM component that is to be joined with a second structure that is or includes an AM component or a non-AM component, and the second structure may be engaged and retained by a second robot. Various operations performed with the first structure (e.g., joining the first structure with one or more other structures, which may include two or more previously joined structures) may be performed at least partially within an assembly cell that includes a plurality of robots. Accordingly, at least one of the robots may be directed (e.g., controlled) during a fixtureless operation with the first structure in order to function in accordance with precision commensurate with the fixtureless operation.

The present disclosure provides various different aspects of directing one or more robots at least partially within an assembly system for assembly operations (including pre-assembly and/or post-assembly operations). It will be appreciated that various features described herein may be practiced together. For example, an example implementation described with respect to one illustration of the present disclosure may be implemented in another embodiment described with respect to another illustration of the present disclosure.

FIG. 10 illustrates a perspective view of an example assembly system 1400. Assembly system 1400 may be employed in various operations associated with the assembly of components, such as robotic assembly of a vehicle or components thereof as described above. Assembly system 1400 may include one or more elements associated with at least a portion of the assembly of a vehicle without any fixtures. For example, one or more elements of assembly system 1400 may be configured for one or more operations in which a first structure is joined with one or more other structures without the use of any fixtures during robotic assembly.

Assembly system 1400 may include a set of robots 1407, 1409, 1411, 1413, 1415, 1417. Robot 507 may be referred to as a “keystone robot.” Assembly system 1400 may include parts holders 1420, 1421, and 1422 that can hold parts and structures for the robots to access, which may for example AM components or non-AM components as described herein.

Assembly system 1400 may also include a computing system 1429 to issue commands to the various controllers of the robots of assembly cell 1405, as described in more detail below. In this example, computing system 1429 is communicatively connected to the robots through a wireless communication. Assembly system 1400 may also include a metrology system 1431 that can accurately measure the positions of the robotic arms of the robots and/or the structures held by the robots. As noted above, in some examples, the structures need not be connected within any fixtures. Instead, at least one of the robots in assembly cell 1405 may provide the functionality expected from fixtures, as described in this disclosure. For example, robots may be configured to directly contact (e.g., using an end effector of a robotic arm) structures to be assembled within assembly cell 1405 so that those structures may be engaged and retained without any fixtures. Further, at least one of the robots may provide the functionality expected from the positioner and/or fixture table. For example, keystone robot 1407 may replace a positioner and/or fixture table in assembly system 1400.

Keystone robot 1407 may include a base and a robotic arm. The robotic arm may be configured for movement, which may be directed by computer-executable instructions loaded into a processor communicatively connected with keystone robot 1407.

Keystone robot 1407 may include and/or be connected with an end effector that is configured to engage and retain a structure, e.g., a first component for assembly. An end effector may be a component configured to interface with at least one structure. Examples of the end effectors may include jaws, grippers, pins, or other similar components capable of facilitating fixtureless engagement and retention of a structure by a robot. In some embodiments, the structure may be a section of a vehicle chassis, body, frame, panel, base piece, suspension component, knuckle, brake components, and the like. For example, the structure may comprise a suspension component that was formed using an AM process.

Keystone robot 1407 may retain the connection with a structure through an end effector, while a set of other structures is connected (either directly or indirectly) to the structure. As noted above, in some examples structures to be retained by at least one of the robots (e.g., the first structure) may be additively manufactured with one or more features that facilitate engagement and retention of those structures by the at least one of the robots without the use of any fixtures.

In retaining the structure, keystone robot 1407 may position (e.g., move) the structure; that is, the position of the structure may be controlled by keystone robot 1407 when retained by the keystone robot. Keystone robot 1407 may retain the structure by “holding” or “grasping” the structure, e.g., using an end effector of a robotic arm of the keystone robot. For example, keystone robot 1407 may retain the structure by causing gripper fingers, jaws, and the like to contact one or more surfaces of the structure and apply sufficient pressure thereto such that the keystone robot controls the position of the structure. That is, the structure may be prevented from moving freely in space when retained by keystone robot 1407, and movement of the structure may be constrained by the keystone robot. As described above, the structure may include one or more features that facilitates the fixtureless engagement and retention of the structure by keystone robot 1407.

As other structures (including subassemblies, substructures of structures, etc.) are connected to the structure, keystone robot 1407 may retain the engagement with the structure through the end effector. The aggregate of the structure and one or more structures connected thereto may be referred to as a structure itself, but may also be referred to as an “assembly” or a “subassembly.” Keystone robot 1407 may retain an engagement with an assembly once the keystone robot has engaged the structure and may align the structures with respect to one another once engaged (e.g., in example implementation of bonding or otherwise using a bonding agent or adhesive to connect the structures).

Robot 1409 of assembly system 1400 may be similar to keystone robot 1407 and, thus, may include respective end effectors configured to engage with structures that may be connected with the structure retained by the keystone robot. In some embodiments, robot 1409, may be referred to as an “assembly robot” and/or “materials handling robot.” Robot 1413 of assembly cell 505 may be used to affect a structural connection between structures. For example, robot 1415 may be referred to as a “adhesive robot.”Adhesive robot 1415 may be similar to the keystone robot 1407, except the adhesive robot may include a tool at the distal end of the robotic arm that is configured to apply structural adhesive to at least one surface of structures fixturelessly retained by the keystone robot and structures fixturelessly retained by assembly robots 1409, 1411 before or after the structures are positioned at joining proximities with respect to other structures for joining with the other structures. The joining proximity can be a position that allows a first structure to be joined to a second structure. In some examples, the first and second structures may be joined though the application of an adhesive while the structures are within the joining proximity and subsequent curing of the adhesive.

However, structural adhesives might take time to cure. If this is the case, the robots retaining the first and second structures, for example, might have to hold the structures at the joining proximity for a period of time in order for the structures to be joined by the structural adhesive or bonding agent once it finally cures. In some examples a quick-cure adhesive can be used first to hold parts together temporarily and then an adhesive or bonding agent (which may have increased strength when compared to the quick cure adhesive) may be applied once the components are assembled.

In this regard, robot 1413 of assembly system 1400 may be used to apply quick-cure adhesive and to cure the adhesive quickly. In this example aspect, a quick-cure UV adhesive may be used, and UV light may be applied by robot 1415, which may be may be referred to as a “UV robot.” UV robot 1415 may be similar to keystone robot 1407, except the UV robot may include a tool at the distal end of the robotic arm that is configured to apply UV light to the adhesive applied by adhesive robot 1413. That is, UV robot 1415 may cure an adhesive after the adhesive is applied to the first structure and/or second structure when the structures are within the joining proximity obtained through direction of at least one of the robotic arms of keystone robot 1407 and/or assembly robots 1409, 1411. In the aspects described above either a second robot (e.g., robot 1413), or the same UV robot (1415) may apply a subsequent or final bonding agent or adhesive.

In some aspects, at least partially replacing fixtures and/or other part-retention tools with curable adhesives may provide a more reliable connection at one or more locations on a structural assembly in need of support-particularly where such locations in need of support are rendered nearly or entirely inaccessible by the fixtures and/or other part-retention tools. In addition, at least partially replacing fixtures and/or other part-retention tools with curable adhesives may provide the ability to add more structures to a structural assembly before application of a (permanent) structural adhesive or bonding agent.

Robot 1417 may further be used to affect a structural connection between structures. For example, robot 1417 may be referred to as a “welding robot.” Welding robot 1417 may be similar to the keystone robot 1407, except the welding robot may include a tool at the distal end of the robotic arm that is configured to weld or join least one surface of structures fixturelessly retained by the keystone robot and structures fixturelessly retained by assembly robots 1409, 1411 before or after the structures are positioned at joining proximities with respect to other structures for joining with the other structures. In some examples, the welding robot 1417 may be configured to uFSW weld as described above with respect to FIGS. 6-8d. The welding proximity can be a position that allows a first structure to be joined to a second structure.

According to various aspects of the disclosure one or more of robots 1407, 1409, 1411, 1413, 1415, 1417 shown in FIG. 10 may be secured to a surface of assembly cell. In other aspects of the disclosure, one or more of the robots may include or may be connected with a component configured to move the robot within assembly cell. For example, a carrier 1419 may be connected to robot 1417.

Any one or combination of the aforementioned robots may further be configured to provide heat management actions as described above (e.g., pump fluid or gas though heat management features, install or fill heat management features with PCM as described herein) and/or seal-off any openings once PCMs are applied to the heat management features of the one or more components.

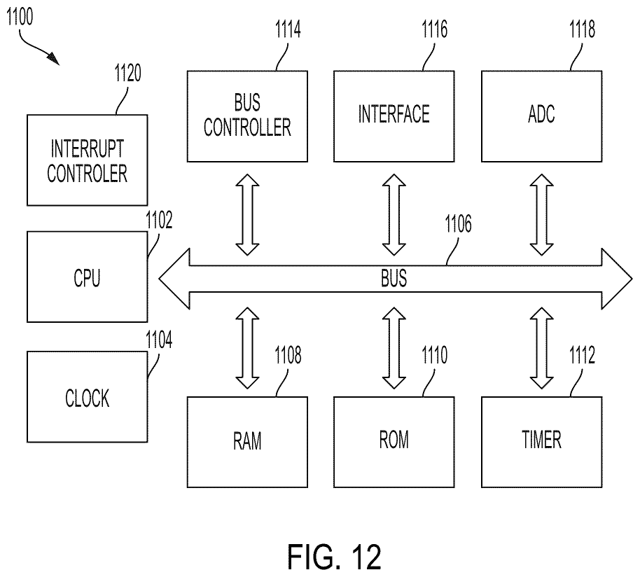

The assembly system may further include a control system for controlling operations described herein. In one example control system, each of the robots 1407, 1409, 1411, 1413, 1415, 1417 may be communicatively connected with a controller, such as a respective one of controllers 1607, 1609, 1611, 1613, 1615, 1617 shown in FIG. 10. Each of controllers 1607, 1609, 1611, 1613, 1615, 1617 may include, for example, a memory and a processor communicatively connected to the memory (e.g., as described with respect to FIGS. 12-15, below). One or more of controllers 1607, 1609, 1611, 1613, 1615, 1617 may be implemented as a single controller that is communicatively connected to one or more of the robots controlled by the single controller.

Computer-readable instructions for performing fixtureless assembly can be stored on the memories of controllers 1607, 1609, 1611, 1613, 1615, 1617, and the processors of the controllers can execute the instructions to cause robots 1407, 1409, 1411, 1413, 1415, 1417 to perform various operations described herein.

Controllers 1607, 1609, 1611, 1613, 1615, 1617 may be communicatively connected to one or more components of an associated robot 1407, 1409, 1411, 1413, 1415, or 1417, for example, via a wired (e.g., bus or other interconnect) and/or wireless (e.g., wireless local area network, wireless intranet) connection. Each of the controllers may issue commands, requests, etc., to one or more components of the associated robot, for example, in order to perform various fixtureless operations. Controllers 1607, 1609, 1611, 1613, 1615, 1617 may issue commands, etc., to a robotic arm of the associated robot 1407, 1409, 1411, 1413, 1415, or 1417 and, for example, may direct the robotic arms based on a set of absolute coordinates relative to a global cell reference frame of assembly cell 1405. In various embodiments, controllers 1607, 1609, 1611, 1613, 1615, 1617 may issue commands, etc., to tools connected to the distal ends of the robotic arms. For example, the controllers may control operations of the tool, including any one or a combination of the operations described herein. Controllers 1607, 1609, 1611, 1613, 1615, 1617 may issue commands, etc., to end effectors at the distal ends of the robotic arms. For example, the controllers may control operations of the end effectors, including, engaging, retaining, and/or manipulating structures described herein, for example to assemble and/or align components with respect to one another.

According to various other aspects, a computing system, such as computing system 1429 (which may include features described below with respect to FIGS. 12-15), similarly having a processor and memory, may be communicatively connected with one or more of controllers 1607, 1609, 1611, 1613, 1615, 1617. In various aspects of the disclosure, the computing system may be communicatively connected with the controllers via a wired and/or wireless connection, such as a local area network, an intranet, a wide area network, and so forth. In some examples, the computing system may be implemented in one or more of controllers 1607, 1609, 1611, 1613, 1615, 1617. In some other examples, the computing system may be located outside assembly cell 1405.

The processor of the computing system may execute instructions loaded from memory, and the execution of the instructions may cause the computing system to issue commands, etc., to the controllers 1607, 1609, 1611, 1613, 1615, 1617, such as by transmitting a message including the command, etc., to one of the controllers over a network connection or other communication link.

In some examples, one or more of the commands may indicate a set of coordinates and may indicate an action to be performed by one of robots 1407, 1409, 1411, 1413, 1415, 1417 associated with the one of the controllers that receives the command. Examples of actions that may be indicated by commands include directing movement of a robotic arm, operating a tool, engaging a structure by an end effector, rotating and/or translating a structure, and so forth. For example, a command issued by a computing system may cause controller 1611 of assembly robot 1411 to direct a robotic arm of assembly robot 1411 so that a distal end of the robotic arm may be located based on a set of coordinates that is indicated by the command.

The instructions loaded from memory and executed by the processor of the computing system, which cause the controllers to control actions of the robots may be based on computer-aided design (CAD) data. One or more CAD models may represent locations corresponding to various elements within the assembly cell 1405. Specifically, a CAD model may represent the locations corresponding to one or more of robots 1407, 1409, 1411, 1413, 1415, 1417. In addition, a CAD model may represent locations corresponding to structures and repositories of the structures (e.g., storage elements, such as parts holder(s), within assembly system 1400 at which structures may be located before being engaged by an assembly robot). The CAD model may represent sets of coordinates corresponding to respective initial or base positions of each of robots 1407, 1409, 1411, 1413, 1415, 1417.

For such CAD modeling, a reference frame for a coordinate system may be defined. The coordinate system may include absolute coordinates, relative coordinates, or a combination thereof. For a set of absolute coordinates, the coordinate frame may be a global coordinate frame or global cell reference frame, and the coordinate frame may include (e.g., may be bounded by and/or may be defined by) an assembly cell or area corresponding to the assembly system 1400.

The coordinate frame may be established based on one or more ground references in-such as one or more laser prisms, each of which may be measured in the assembly cell so that, in the aggregate, a reference frame is defined with a number of reference points corresponding to the number of laser prisms. Thus, a CAD model corresponding to assembly area may be an as-built CAD model, which may represent the assembly area more accurately than a nominal CAD model. Absolute coordinates based on CAD modeling may provide a degree of accuracy that is acceptable for fixtureless assembly of components. In one example, directing robots 507, 509, 511, 1413, 1415, 1417 based on absolute coordinates established through CAD modeling may adhere to various industry and/or safety standards that are to be observed when assembling a vehicle.

In some example implementations of the disclosure, relative coordinates may be used for assembly system 1400, for example, as an alternative or supplement to an absolute coordinate system. In particular, relative coordinates may be used for some portions of the fixtureless joining process in which a second structure may be joined to the first structure and/or joined to another structure. For example, a controller associated with an assembly robot may direct robotic arm of the assembly robot to a joining position based on a set of absolute coordinates defined with respect to the global cell reference frame. The position of the robotic arm may be measured (e.g., by the controller of the assembly robot, by the controller of the keystone robot, by another controller and/or processing system, etc.) after assembly robot reaches the joining position based on the set of absolute coordinates, and the measured position of assembly robot may be provided to controller of the keystone robot. The controller of the keystone robot may position the robotic arm of the keystone robot based on the measured position of the assembly robot's robotic arm. Thus, the keystone robot's arm may be positioned relative to the assembly robot's arm, for example, instead of correcting the respective positions of each of the keystone robot and the assembly robot according to the global cell reference frame while the controllers may remain agnostic to the positions of the keystone robot or the assembly robot.

In addition, a CAD model may represent one or more of the operations that are to be performed for construction of at least an assembly or sub-assembly of components. In other words, a CAD model may simulate the assembly procedure of assembly system 500 and, therefore, may simulate each of the movements and/or actions performed by one or more of the robots. The CAD simulation may be translated into a set of discrete operations (e.g., a discrete operation may include direction for an associated set of coordinates), which may be physically performed by one or more of the robots.

Each of robots 1407, 1409, 1411, 1413, 1415, 1417 may include features that are common across all or some of the robots. Each robotic arm of robots 1407, 1409, 1411, 1413, 1415, 1417 may include a distal end, oppositely disposed from the proximal end of the robotic arm with an end effector and/or a tool, such as an adhesive application tool, curing tool, and so forth. An end effector or a tool may be at the distal end of a robotic arm. In some embodiments, the distal end of a robotic arm may be connected to an end effector or a tool (or tool flange) through at least one rotation and/or translation mechanism, which may provide at least one degree of freedom in movement of the tool and/or movement of a structure engaged and retained by the tool of the robotic arm.

According to some embodiments, a tool flange and/or tool may provide one or more additional degrees of freedom (DoF) for rotation and/or translation of a structure engaged and retained by the tool. Such additional degrees of freedom may supplement the one or more degrees of freedom provided through one or more mechanisms connecting a base to the proximal end of a robotic arm and/or connecting the distal end of a robotic arm to the tool (or tool flange). Illustratively, a robotic arm of at least one of robots 1407, 1409, 1411, 1413, 1415, 1417 may include at least one joint configured for rotation and/or translation at a distal and/or proximal end, such as an articulating joint, a ball joint, and/or other similar joint.

One or more of the respective connections of robots 1407, 1409, 1411, 1413, 1415, 1417 (e.g., one or more rotational and/or translational mechanisms connecting various components of one of the robots), a respective tool flange, and/or a respective tool may provide at least a portion (and potentially all) of six DoF for a structure engaged and retained by the robots. The six DoF may include forward/backward (e.g., surge), up/down (e.g., heave), left/right (e.g., sway) for translation in space and may further include yaw, pitch, and roll for rotation in space. It is noted that the aforementioned operations are provided as examples. While some specific examples are given, one having ordinary skill in the art would understand that additional possibilities of automated, semi-automated, or manual control of the systems and devices disclosed.

As noted above, part of or incorporating various features and methods described herein may require one or more microcontrollers for controlling any one or combination of the operations described herein (e.g., the operations of the AM system, non-AM system, and/or assembly system). Various components of an example of such a controller 1000 are shown in representative block diagram form in FIG. 12. In FIG. 12, the controller 1000 includes a CPU 1002, clock 1004, RAM 1008, ROM 1010, a timer 1012, a BUS controller 1014, an interface 1016, and an analog-to-digital converter (ADC) 1018 interconnected via a BUS 1006. The CPU 1002 may be implemented as one or more single core or multi-core processors, and receive signals from an interrupt controller 1020 and a clock 1004. The clock 1004 may set the operating frequency of the entire microcontroller 1000 and may include one or more crystal oscillators having predetermined frequencies. Alternatively, the clock 1004 may receive an external clock signal. The interrupt controller 1020 may also send interrupt signals to the CPU, to suspend CPU operations. The interrupt controller 1020 may transmit an interrupt signal to the CPU when an event requires immediate CPU attention.

The RAM 1008 may include one or more Static Random Access Memory (SRAM), Dynamic Random Access Memory (DRAM), Synchronous Dynamic Random Access Memory (SDRAM), Double Data-Rate Random Access Memory (DDR SDRAM), or other suitable volatile memory. The Read-only Memory (ROM) 1010 may include one or more Programmable Read-only Memory (PROM), Erasable Programmable Read-only Memory (EPROM), Electronically Erasable Programmable Read-only memory (EEPROM), flash memory, or other types of non-volatile memory.

The timer 1012 may keep time and/or calculate the amount of time between events occurring within the controller 1000, count the number of events, and/or generate baud rate for communication transfer. The BUS controller 1014 may prioritize BUS usage within the controller 1000. The ADC 1018 may allow the controller 1000 to send out pulses to signal other devices.

The interface 1016 may comprise an input/output device that allows the controller 1000 to exchange information with other devices. In some implementations, the interface 1016 may include one or more of a parallel port, a serial port, or other computer interfaces.

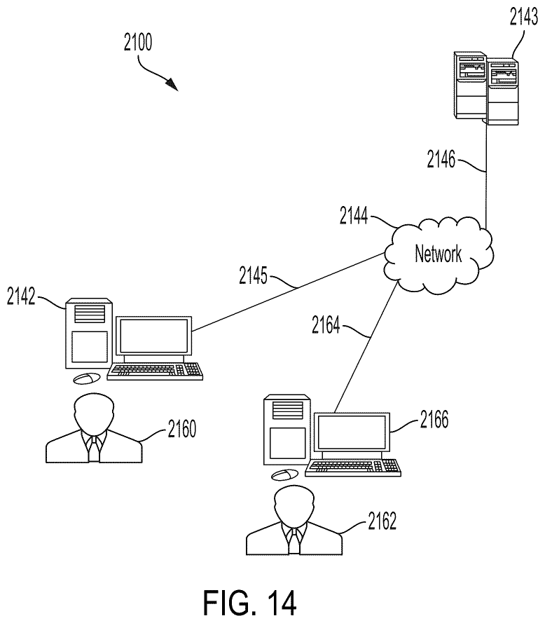

In addition, aspects of the present disclosures may be implemented using hardware, software, or a combination thereof and may be implemented in one or more computer systems or other processing systems. In an aspect of the present disclosures, features are directed toward one or more computer systems capable of carrying out the functionality described herein. An example of such the computer system 2000 is shown in FIG. 14.

The computer system 2000 may include one or more processors, such as processor 2004. The processor 2004 may be connected to a communication infrastructure 2006 (e.g., a communications bus, cross-over bar, or network). Various software aspects are described in terms of this example computer system. After reading this description, it will become apparent to a person skilled in the relevant art(s) how to implement aspects of the disclosures using other computer systems and/or architectures.

The computer system 2000 may include a display interface 2002 that forwards graphics, text, and other data from the communication infrastructure 2006 (or from a frame buffer not shown) for display on a display unit 2030, Computer system 2000 also includes a main memory 2008, preferably random access memory (RAM), and may also include a secondary memory 2010. The secondary memory 2010 may include, for example, a hard disk drive 2012, and/or a removable storage drive 2014, representing a floppy disk drive, a magnetic tape drive, an optical disk drive, a universal serial bus (USB) flash drive, etc. The removable storage drive 2014 reads from and/or writes to a removable storage unit 2018 in a well-known manner. Removable storage unit 2018 represents a floppy disk, magnetic tape, optical disk, USB flash drive etc., which is read by and written to removable storage drive 2014. As will be appreciated, the removable storage unit 2018 includes a computer usable storage medium having stored therein computer software and/or data.

Alternative aspects of the present disclosure may include secondary memory 2010 and may include other similar devices for allowing computer programs or other instructions to be loaded into computer system 2000. Such devices may include, for example, a removable storage unit 2022 and an interface 2020. Examples of such may include a program cartridge and cartridge interface (such as that found in video game devices), a removable memory chip (such as an erasable programmable read only memory (EPROM), or programmable read only memory (PROM)) and associated socket, and other removable storage units 2022 and interfaces 2020, which allow software and data to be transferred from the removable storage unit 2022 to computer system 2000.

Computer system 2000 may also include a communications interface 2024. Communications interface 2024 allows software and data to be transferred between computer system 2000 and external devices. Examples of communications interface 2024 may include a modem, a network interface (such as an Ethernet card), a communications port, a Personal Computer Memory Card International Association (PCMCIA) slot and card, etc. Software and data transferred via communications interface 2024 are in the form of signals 2028, which may be electronic, electromagnetic, optical or other signals capable of being received by communications interface 2024. These signals 2028 are provided to communications interface 2024 via a communications path (e.g., channel) 2026. This path 2026 carries signals 2028 and may be implemented using wire or cable, fiber optics, a telephone line, a cellular link, an RF link and/or other communications channels. In this document, the terms “computer program medium” and “computer usable medium” are used to refer generally to media such as a removable storage drive 2018, a hard disk installed in hard disk drive 2012, and signals 2028. These computer program products provide software to the computer system 2000. Aspects of the present disclosures are directed to such computer program products.

Computer programs (also referred to as computer control logic) are stored in main memory 2008 and/or secondary memory 2010. Computer programs may also be received via communications interface 2024. Such computer programs, when executed, enable the computer system 2000 to perform the features in accordance with aspects of the present disclosures, as discussed herein. In particular, the computer programs, when executed, enable the processor 2004 to perform the features in accordance with aspects of the present disclosures. Accordingly, such computer programs represent controllers of the computer system 2000.

In an aspect of the present disclosures where the method is implemented using software, the software may be stored in a computer program product and loaded into computer system 2000 using removable storage drive 2014, hard drive 2012, or communications interface 2020. The control logic (software), when executed by the processor 2004, causes the processor 2004 to perform the functions described herein. In some examples, the computer system 2000 may include one or more AM controller(s) 1904, e.g., for controlling any one or combination of the AM systems described above with respect to FIGS. 1a-3 and/or weld controller 1905 for controlling any one or combination of steps described herein. In another aspect of the present disclosures, the system is implemented primarily in hardware using, for example, hardware components, such as application specific integrated circuits (ASICs). Implementation of the hardware state machine so as to perform the functions described herein will be apparent to persons skilled in the relevant art(s).

FIG. 14 is a block diagram of various example communication system components usable in accordance with an aspect of the present disclosure. The communication system 2100 includes one or more accessors 2160, 2162 (which may for example comprise any of the aforementioned systems and features) and one or more terminals 2142, 2166. In one aspect, data for use in accordance with aspects of the present disclosure is, for example, input and/or accessed by accessors 2160, 2162 via terminals 2142, 2166, such as personal computers (PCs), minicomputers, mainframe computers, microcomputers, telephonic devices, or wireless devices, such as personal digital assistants (“PDAs”) or a hand-held wireless devices coupled to a server 2143, such as a PC, minicomputer, mainframe computer, microcomputer, or other device having a processor and a repository for data and/or connection to a repository for data, via, for example, a network 2144, such as the Internet or an intranet, and couplings 2145, 2146, 2164. The couplings 2145, 2146, 2164 include, for example, wired, wireless, or fiberoptic links. In another example variation, the method and system in accordance with aspects of the present disclosure operate in a stand-alone environment, such as on a single terminal.

Aspects of the disclosure are further described in the following clauses:

Clause 1. An additively manufactured component configured to be welded to a second component, the additively manufactured component comprising: a joining portion configured to be welded to the second component; and a heat management feature for removing heat from the joining portion when the joining portion is welded to the second component.

Clause 2. The additively manufactured component of clause 1, wherein the heat management feature includes a channel with a lattice structure therein.

Clause 3. The additively manufactured component of any of the preceding clauses, wherein the channel includes an inlet feature and an outlet feature in fluid communication with the channel, wherein a fluid is provided via the inlet feature and removed via the outlet feature as the joining portion is welded to the second component.

Clause 4. The additively manufactured component of any of the preceding clauses, wherein the channel includes an opening for filling the channel with a phase change material that removes heat energy from the joining portion as the phase change material undergoes a phase-change.

Clause 5. The additively manufactured component of any of the preceding clauses, wherein the phase change material includes a nitrate or hydroxide.

Clause 6. The additively manufactured component of any of the preceding clauses, wherein the phase change material changes phases and removes heat from the joining portion during welding of the joining portion to the second component.

Clause 7. The additively manufactured component of any of the preceding clauses, wherein the joining portion includes one or more openings proximal to the joining portion for placement of an adhesive or for welding therethrough to join the additively manufactured component to the second component.

Clause 8. The additively manufactured component of any of the preceding clauses, wherein the joining portion comprises a weld area increasing feature that corresponds with a second component weld area increasing feature of the second component.

Clause 9. The additively manufactured component of any of the preceding clauses, wherein the weld area increasing feature is a non-linear pattern.

Clause 10. The additively manufactured component of any of the preceding clauses, wherein the joining portion is welded to the second component via a friction-stir welding process.

Clause 11. The additively manufactured component of any of the preceding clauses, further comprising a thermal blocking feature, wherein the thermal blocking feature includes a cavity in the additively manufactured component.

Clause 12. A structural vehicle component comprising: a first additively manufactured component with a first component first joining feature and a first component second joining feature; a second additively manufactured component with a second component first joining feature joined to the first component first joining feature via an adhesive and a second component second joining feature; and a joint structure spanning from the first component second joining feature to the second component second joining feature, wherein a first end of the joint structure is welded to the first component second joining feature and a second end of the joint structure is welded to the second component second joining feature.

Clause 13. The structural vehicle component of clause 12, wherein the first end of the joint structure is friction-stir welded to the first component second joining feature and the second end of the joint structure is friction-stir welded to the second component second joining feature.

Clause 14. The structural vehicle component of any of the preceding clauses, wherein at least the joint structure or the first component second joining feature include a heat management feature for removing heat generated during welding of the first component second joining feature and the joint structure.

Clause 15. The structural vehicle component of any of the preceding clauses, wherein the heat management feature includes a cavity or channel with a lattice structure therein.

Clause 16. The structural vehicle component of any of the preceding clauses, wherein the cavity or channel includes an inlet feature and an outlet feature in fluid communication with the channel or cavity, wherein a fluid is provided via the inlet feature and removed via the outlet feature as the first component second joining feature is welded to the joint structure.

Clause 17. The structural vehicle component of any of the preceding clauses, wherein the cavity or channel includes an opening for filling the cavity or channel with a phase change material.

Clause 18. The structural vehicle component of any of the preceding clauses, wherein the phase change material includes a nitrate or hydroxide.

Clause 19. The structural vehicle component of any of the preceding clauses, wherein the phase change material changes phases and removes heat generated during welding of the first component second joining feature and joint structure.

Clause 20. The structural vehicle component of any of the preceding clauses, wherein a first end of the joint structure is welded to the first component second joining feature via a friction-stir welding process.

Clause 21. The structural vehicle component of any of the preceding clauses, wherein at least the joint structure or the first component second joining feature include a heat blocking cavity.

Clause 22. A method for joining an additively manufactured component to a second component, the method comprising: joining an additively manufactured component joining portion of the additively manufactured component to a second component joining portion of the second component via welding while removing heat generated by the welding via a heat management feature of the additively manufactured component.

Clause 23. The method of clause 22, wherein the heat generated by the welding is removed by providing a fluid or material to a channel or cavity of the heat management feature.

Clause 24. The method of any of the preceding clauses, wherein the fluid channel or cavity includes an inlet feature and an outlet feature in fluid communication with the channel, wherein a fluid is provided via the inlet feature and removed via the outlet feature as the additively manufactured component is welded to the second component.

Clause 25. The method of any of the preceding clauses, wherein the channel includes an opening for filling the channel or cavity with a phase change material that removes heat energy as the phase change material undergoes a phase-change.

Clause 26. The method of any of the preceding clauses, wherein the phase change material includes a nitrate or hydroxide.

Clause 27. The method of any of the preceding clauses, wherein the additively manufactured component joining portion includes one or more openings for placement of an adhesive or for welding therethrough.

The present disclosure is provided to enable any person skilled in the art to practice the various aspects described herein. Various modifications to these example embodiments presented throughout the present disclosure will be readily apparent to those skilled in the art, and the concepts disclosed herein may be applied to other techniques for printing nodes and interconnects. Thus, the claims are not intended to be limited to the example embodiments presented throughout the disclosure, but are to be accorded the full scope consistent with the language claims. All structural and functional equivalents to the elements of the example embodiments described throughout the present disclosure that are known or later come to be known to those of ordinary skill in the art are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f), or analogous law in applicable jurisdictions, unless the element is expressly recited using the phrase “means for” or, in the case of a method claim, the element is recited using the phrase “step for.”

What is claimed is:

1. An additively manufactured component configured to be welded to a second component, the additively manufactured component comprising:
a joining portion configured to be welded to the second component; and
a heat management feature for removing heat from the joining portion when the joining portion is welded to the second component.

2. The additively manufactured component of claim 1, wherein the heat management feature includes a channel with a lattice structure therein.

3. The additively manufactured component of claim 2, wherein the channel includes an inlet feature and an outlet feature in fluid communication with the channel, wherein a fluid is provided via the inlet feature and removed via the outlet feature as the joining portion is welded to the second component.

4. The additively manufactured component of claim 2, wherein the channel includes an opening for filling the channel with a phase change material that removes heat energy from the joining portion as the phase change material undergoes a phase-change.

5. The additively manufactured component of claim 4, wherein the phase change material includes a nitrate or hydroxide.

6. The additively manufactured component of claim 4, wherein the phase change material changes phases and removes heat from the joining portion during welding of the joining portion to the second component.

7. The additively manufactured component of claim 1, wherein the joining portion includes one or more openings proximal to the joining portion for placement of an adhesive or for welding therethrough to join the additively manufactured component to the second component.

8. The additively manufactured component of claim 1, wherein the joining portion comprises a weld area increasing feature that corresponds with a second component weld area increasing feature of the second component.

9. The additively manufactured component of claim 8, wherein the weld area increasing feature is a non-linear pattern.

10. The additively manufactured component of claim 1, wherein the joining portion is welded to the second component via a friction-stir welding process.

11. The additively manufactured component of claim 1, further comprising a thermal blocking feature, wherein the thermal blocking feature includes a cavity in the additively manufactured component.

12. A structural vehicle component comprising:
a first additively manufactured component with a first component first joining feature and a first component second joining feature;
a second additively manufactured component with a second component first joining feature joined to the first component first joining feature via an adhesive and a second component second joining feature; and
a joint structure spanning from the first component second joining feature to the second component second joining feature, wherein a first end of the joint structure is welded to the first component second joining feature and a second end of the joint structure is welded to the second component second joining feature.

13. The structural vehicle component of claim 12, wherein the first end of the joint structure is friction-stir welded to the first component second joining feature and the second end of the joint structure is friction-stir welded to the second component second joining feature.

14. The structural vehicle component of claim 12, wherein at least the joint structure or the first component second joining feature include a heat management feature for removing heat generated during welding of the first component second joining feature and the joint structure.

15. The structural vehicle component of claim 14, wherein the heat management feature includes a cavity or channel with a lattice structure therein.

16. The structural vehicle component of claim 15, wherein the cavity or channel includes an inlet feature and an outlet feature in fluid communication with the channel or cavity, wherein a fluid is provided via the inlet feature and removed via the outlet feature as the first component second joining feature is welded to the joint structure.

17. The structural vehicle component of claim 15, wherein the cavity or channel includes an opening for filling the cavity or channel with a phase change material.

18. The structural vehicle component of claim 17, wherein the phase change material includes a nitrate or hydroxide.

19. The structural vehicle component of claim 18, wherein the phase change material changes phases and removes heat generated during welding of the first component second joining feature and joint structure.

20. The structural vehicle component of claim 19, wherein a first end of the joint structure is welded to the first component second joining feature via a friction-stir welding process.

21. The structural vehicle component of claim 12, wherein at least the joint structure or the first component second joining feature include a heat blocking cavity.

22. A method for joining an additively manufactured component to a second component, the method comprising:
joining an additively manufactured component joining portion of the additively manufactured component to a second component joining portion of the second component via welding while removing heat generated by the welding via a heat management feature of the additively manufactured component.

23. The method of claim 22, wherein the heat generated by the welding is removed by providing a fluid or material to a channel or cavity of the heat management feature.

24. The method of claim 23, wherein the fluid channel or cavity includes an inlet feature and an outlet feature in fluid communication with the channel, wherein a fluid is provided via the inlet feature and removed via the outlet feature as the additively manufactured component is welded to the second component.

25. The method of claim 23, wherein the channel includes an opening for filling the channel or cavity with a phase change material that removes heat energy as the phase change material undergoes a phase-change.

26. The method of claim 25, wherein the phase change material includes a nitrate or hydroxide.

27. The method of claim 26, wherein the additively manufactured component joining portion includes one or more openings for placement of an adhesive or for welding therethrough.
